(19) United States
(12) Patent Application Publication
(10) Pub. No.: US 2022/0108241 A1
(43) Pub. Date: Apr. 7, 2022

(54) SYSTEMS AND METHODS FOR PREDICTING OPERATIONAL EVENTS

(71) Applicant: BANK OF MONTREAL, Toronto (CA)

(72) Inventor: Adam JALAL, Toronto (CA)

(73) Assignee: BANK OF MONTREAL, Toronto (CA)

(21) Appl. No.: 17/495,737

(22) Filed: Oct. 6, 2021

Related U.S. Application Data
(60) Provisional application No. 63/088,261, filed on Oct. 6, 2020.

(51) Int. Cl. G06Q 10/06; G06Q 30/02; G06N 5/02; G06N 20/00

(52) U.S. Cl. CPC G06Q 10/0635; G06N 20/00; G06N 5/02; G06Q 30/0201

(57) ABSTRACT

A system and method for predicting operational loss events in transactions using artificial intelligence modeling. The system and method include receiving, by one or more processors, a request for a risk score associated with an organization; applying, by the one or more processors, a scoring dataset to a risk predictive model that is trained with a training dataset causing the risk predictive model to generate one or more risk scores based on the scoring data, the one or more risk scores indicative of a probability for an operational loss event to occur responsive to a transaction by the organization; and sending, by the one or more processors, a message that includes the one or more risk scores to a client device.

### CROSS REFERENCE TO RELATED APPLICATIONS

This application claims priority to U.S. Provisional Patent Application No. 63/088,261, filed Oct. 6, 2020, which is incorporated herein by reference in its entirety for all purposes.

### TECHNICAL FIELD

This application relates generally to artificial intelligence in the field of computer science, and more particularly to systems and methods for predicting operational loss events using artificial intelligence modeling.

### BACKGROUND

Predictive analytics is a data mining technique that attempts to predict an outcome. Predictive analytics uses predictors or known features to create predictive models that are used in obtaining an output. A predictive model reflects how different points of data interact with each other to produce an outcome. Predictive modeling is the process of using known results to create, process, and validate a model that can be used to forecast future outcomes. Two of the most widely used predictive modeling techniques are regression and neural networks.

Operational losses in business are a result of failure in the process, people, and/or systems. They manifest in many ways, including user error such as input errors, missed execution and miscommunication. Today, most businesses apply a uniform approach to preventing loss. This is because they only know about losses that have happened in the past, not about what is likely to happen in the future.

Businesses use a mix of manual, semi-automated, and automated steps to execute key processes and various steps of these processes may be executed by users. While automated processes may flex to manage increased throughput, bespoke orders or atypical information, manual and semi-automated processes may be limited by the capacity of each manual step. Although the likelihood of costly errors is higher when manual steps become stressed, not all processes are stressed equally.

Conventional systems, however, are incapable of accurately predicting when operational losses are likely to occur for a variety of different reasons. For one, the inter-relationship between users, markets, economic factors, processes and systems are too complicated to model and/or characterize when using conventional systems and methods. As a result, the accuracy of the predictive model shifts and/or degrades to the point where the predictive model is incapable of accurately predicting when an operational loss could occur and determining how to prevent the operational losses from occurring.

### SUMMARY

For the aforementioned reasons, there is a long-felt desire in designing solutions that can mitigate and/or prevent operational loss events related to wrongful execution of a transaction (e.g., when an employee instructs a computer to execute a transaction). Disclosed herein are methods and systems that use artificial intelligence models (sometimes referred to as, “models” or “predictive models”) to predict the likelihood of operational loss events in transactions to provide recommendations for improving the process for executing the transaction.

In an embodiment, a method comprises receiving, by one or more processors, a request for one or more risk scores associated with a plurality of transactions executed by an organization, the one or more risk scores indicating a probability of one or more users instructing execution of a transaction using an incorrect transaction attribute, the transaction causing an operational loss to the organization; applying, by the one or more processors, a scoring dataset to a risk predictive model that is trained with a training dataset causing the risk predictive model to generate one or more risk scores based on the scoring dataset; and sending, by the one or more processors, a message that includes the one or more risk scores to a client device.

In another embodiment, a system comprises one or more processors; and one or more computer-readable storage mediums storing instructions which, when executed by the one or more processors, cause the one or more processors to receiving a request for one or more risk scores associated with a plurality of transactions executed by an organization, the one or more risk scores indicating a probability of one or more users instructing execution of a transaction using an incorrect transaction attribute, the transaction causing an operational loss to the organization; applying a scoring dataset to a risk predictive model that is trained with a training dataset causing the risk predictive model to generate one or more risk scores based on the scoring dataset; and sending a message that includes the one or more risk scores to a client device.

In another embodiment, a non-transitory computer-readable storage medium stores instructions which, when executed by one or more processors of a classical computer, cause the one or more processors to perform operations comprising receiving a request for one or more risk scores associated with a plurality of transactions executed by an organization, the one or more risk scores indicating a probability of one or more users instructing execution of a transaction using an incorrect transaction attribute, the transaction causing an operational loss to the organization; applying a scoring dataset to a risk predictive model that is trained with a training dataset causing the risk predictive model to generate one or more risk scores based on the scoring dataset; and sending a message that includes the one or more risk scores to a client device.

In another embodiment, a method comprises receiving, by one or more processors, a recommendation request for improving a procedure for instructing an execution of a transaction by one or more users of an organization; determining, by the one or more processors executing a risk predictive model that is trained using historical operational loss data, a risk indicative of a probability for the one or more users to cause at least one operational loss event when instructing the execution of the transaction having an error due to the procedure; and generating, by the one or more processors executing a process optimizer predictive model, one or more recommendations that mitigate the risk responsive to the one or more users instructing execution of a transaction using a revised procedure.

In another embodiment, a server comprises a processor and a non-transitory computer-readable medium containing instructions that when executed by the processor causes the processor to perform operations comprising: receiving a recommendation request for improving a procedure for instructing an execution of a transaction by one or more users of an organization; determining, by executing a risk predictive model that is trained using historical operational loss data, a risk indicative of a probability for the one or more users to cause at least one operational loss event when instructing the execution of the transaction having an error due to the procedure; and generating, by executing a process optimizer predictive model, one or more recommendations that mitigate the risk responsive to the one or more users instructing execution of a transaction using a revised procedure.

In another embodiment, a system comprises a computer device having a processor and a server in communication with the computer device, the server configured to: receive a recommendation request for improving a procedure for instructing an execution of a transaction by one or more users of an organization; determine, by executing a risk predictive model that is trained using historical operational loss data, a risk indicative of a probability for the one or more users to cause at least one operational loss event when instructing the execution of the transaction having an error due to the procedure; and generate, by executing a process optimizer predictive model, one or more recommendations that mitigate the risk responsive to the one or more users instructing execution of a transaction using a revised procedure.

In another embodiment, a method comprises receiving, by one or more processors, a request for one or more risk scores associated with a user of an organization who instructs execution of transactions; applying, by the one or more processors, a scoring dataset to a risk predictive model that is trained with a training dataset comprising historical operational loss data causing the risk predictive model to generate the one or more risk scores based on the scoring dataset, the one or more risk scores indicative of a probability for the user causing an operational loss event when instructing an execution of a transaction having an incorrect transaction attribute; and sending, by the one or more processors to a client device, a message that includes the one or more risk scores to a client device.

In another embodiment, a system comprises a server comprising a processor and a non-transitory computer-readable medium containing instructions that when executed by the processor causes the processor to perform operations comprising; receiving a request for one or more risk scores associated with a user of an organization who instructs execution of transactions; applying a scoring dataset to a risk predictive model that is trained with a training dataset comprising historical operational loss data causing the risk predictive model to generate the one or more risk scores based on the scoring dataset, the one or more risk scores indicative of a probability for the user causing an operational loss event when instructing an execution of a transaction having an incorrect transaction attribute; and sending, to a client device, a message that includes the one or more risk scores to a client device.

In another embodiment, a system comprises a client device; and a server in communication with the client device, the server configured to: receive a request for one or more risk scores associated with a user of an organization who instructs execution of transactions; apply a scoring dataset to a risk predictive model that is trained with a training dataset comprising historical operational loss data causing the risk predictive model to generate the one or more risk scores based on the scoring dataset, the one or more risk scores indicative of a probability for the user causing an operational loss event when instructing an execution of a transaction having an incorrect transaction attribute; and send, to a client device, a message that includes the one or more risk scores to a client device.

In another embodiment, a method comprises detecting, by one or more processors, an occurrence of an event causing a change in accuracy of a risk predictive model of operational loss; determining, by the one or more processors, the change in accuracy of the risk predictive model responsive to the occurrence of the event, the risk predictive model being trained with a training dataset causing the risk predictive model to generate a risk score indicative of a probability for an operational loss event to occur from a transaction having an incorrect transaction attribute, wherein the training dataset comprises operational loss data before the occurrence of the event; and re-training, by the one or more processors responsive to determining the change in accuracy, the risk predictive model using a second training dataset comprising operational loss data after the occurrence of the event instead of the training dataset.

In another embodiment, a system comprises a server comprising a processor and a non-transitory computer-readable medium containing instructions that when executed by the processor causes the processor to perform operations comprising detecting an occurrence of an event causing a change in accuracy of a risk predictive model of operational loss; determining the change in accuracy of the risk predictive model responsive to the occurrence of the event, the risk predictive model being trained with a training dataset causing the risk predictive model to generate a risk score indicative of a probability for an operational loss event to occur from a transaction having an incorrect transaction attribute, wherein the training dataset comprises operational loss data before the occurrence of the event; and re-training, responsive to determining the change in accuracy, the risk predictive model using a second training dataset comprising operational loss data after the occurrence of the event instead of the training dataset.

In another embodiment, a system comprises a client device; and a server in communication with the client device, the server configured to: detecting an occurrence of an event causing a change in accuracy of a risk predictive model of operational loss; determining the change in accuracy of the risk predictive model responsive to the occurrence of the event, the risk predictive model being trained with a training dataset causing the risk predictive model to generate a risk score indicative of a probability for an operational loss event to occur from a transaction having an incorrect transaction attribute, wherein the training dataset comprises operational loss data before the occurrence of the event; and re-training, responsive to determining the change in accuracy, the risk predictive model using a second training dataset comprising operational loss data after the occurrence of the event instead of the training dataset.

In another embodiment, a system comprises a first database configured to receive and store a feed of a first dataset for a first entity; a second database configured to receive and store a feed of a second dataset for a second entity; a third database configured to receive and store a feed of a shared dataset accessible to the first entity and the second entity; a server in communication with the first database, the second database, and the third database, the server configured to: train an artificial intelligence model using the first dataset to generate at least one weight factor of the artificial intelligence model trained for the first entity and store the at least one weight factor on the first database; train the artificial intelligence model using the second dataset to generate at least one weight factor of the artificial intelligence model trained for the second entity and store the at least one weight factor on the second database; execute the artificial intelligence model using the first dataset, the shared dataset, and the at least one weight factor for the first entity to transmit a first output to the first entity; and execute the artificial intelligence model using the second dataset, the shared dataset, and the at least one weight factor for the second entity to transmit a second output to the second entity.

In another embodiment, a method comprises training, by a processor, an artificial intelligence model using a first dataset for a first entity to generate at least one first weight factor of the artificial intelligence model trained for the first entity and store the at least one weight factor on a first database; training, by a processor, the artificial intelligence model using a second dataset for a second entity to generate at least one second weight factor of the artificial intelligence model trained for the second entity and store the at least one weight factor on a second database; executing, by the processor, the artificial intelligence model using the first dataset, a shared dataset, and the at least one first weight factor for the first entity to transmit a first output to the first entity; and execute the artificial intelligence model using the second dataset, the shared dataset, and the at least one second weight factor for the second entity to transmit a second output to the second entity.

In another embodiment, a system comprises a server comprising a processor and a non-transitory computer-readable medium containing instructions that when executed by the processor causes the processor to perform operations comprising training, by a processor, an artificial intelligence model using a first dataset for a first entity to generate at least one weight factor of the artificial intelligence model trained for the first entity and store the at least one weight factor on a first database; training, by a processor, the artificial intelligence model using a second dataset for a second entity to generate at least one weight factor of the artificial intelligence model trained for the second entity and store the at least one weight factor on a second database; executing, by the processor, the artificial intelligence model using the first dataset, a shared dataset, and the at least one weight factor for the first entity to transmit a first output to the first entity; and execute the artificial intelligence model using the second dataset, the shared dataset, and the at least one weight factor for the second entity to transmit a second output to the second entity.

These and other features, together with the organization and manner of operation thereof, will become apparent from the following detailed description when taken in conjunction with the accompanying drawings.

### BRIEF DESCRIPTION OF THE FIGURES

FIG. 1 is a block diagram depicting an example environment for predicting operational loss events in transactions using artificial intelligence modeling, according to some embodiments.

FIG. 2A is a block diagram depicting an example model management system, according to some embodiments.

FIG. 2B is a block diagram depicting an example client device, according to some embodiments.

FIG. 2C is a block diagram depicting an example administrator device, according to some embodiments.

FIG. 3 is a graphical user interface of an example application depicting a method for displaying model evaluation results for a predictive model, according to some embodiments.

FIG. 4 is a block diagram depicting trained relationships, scored relationships, and concept drifts in relation to input features for an example predictive model of the environment in FIG. 1, according to some arrangements.

FIG. 5 is a graphical user interface of an example application depicting an Area Under the Curve (AUC) for calculating model accuracy for a predictive model, according to some embodiments.

FIG. 6A is a flow diagram depicting a method for using artificial intelligence modeling to determine the probability for an operational loss event to occur responsive to an execution of a transaction by an organization, according to some embodiments.

FIG. 6B is a flow diagram depicting a method for using artificial intelligence modeling to determine the probability for a one or more users of an organization to cause an operational loss event related to wrongful execution of a transaction, according to some embodiments.

FIG. 6C is a flow diagram depicting a method for using artificial intelligence modeling to generate recommendations for mitigating the risk associated with one or more users instructing execution of a transaction, according to some embodiments.

FIG. 6D is a flow diagram depicting a method for using artificial intelligence modeling to determine model accuracy of a risk predictive model responsive to detecting an occurrence of changing conditions and/or new events, according to some embodiments.

FIG. 7 is a graphical user interface of an example application depicting a method for displaying a plurality of risk scores produced by predictive models, according to some embodiments.

FIG. 8 is a graphical user interface of an example application depicting a method for displaying a plurality of risk scores produced by predictive models, according to some embodiments.

FIG. 9 is a graphical user interface of an example application depicting a method for displaying a plurality of risk scores produced by predictive models, according to some embodiments.

FIG. 10 is a graphical user interface of an example application depicting a method for displaying a plurality of risk scores produced by predictive models, according to some embodiments.

FIG. 11 illustrates a non-limiting example of an environment for predicting operational loss events in transactions using artificial intelligence modeling, according to some embodiments.

FIG. 12 illustrates a flow diagram depicting a method for using artificial intelligence modeling to determine the probability for an operational loss event to occur, according to some embodiments.

Like reference numbers and designations in the various drawings indicate like elements.

### DETAILED DESCRIPTION

The present disclosure is directed to systems and methods for predicting operational loss events in transactions using artificial intelligence modeling. In one aspect, an operational loss model can determine the probability for an operational risk event to occur responsive to an execution of an erroneous or inappropriate transaction. For instance, one or more users (e.g., employees, non-employees, independent contractors, etc.) associated with an organization may input into a computer one or more transaction attributes and to instruct a server to conduct a transaction. However, the user may input a wrong transaction attribute (e.g., wrong account number, recipient name, value, or other input or selection). In another aspect, a performance model can determine the probability for a one or more users associated with an organization to cause an operational risk event when instructing a transaction to be executed. For instance, the performance model determines the probability of a trader entering a wrong account number while filling out a trade instructions form using a computing device (e.g., operational risk event or “event”), which will eventually lead to an operational loss. In yet another aspect, a process optimizer model may generate recommendations for mitigating the risk associated with one or more users instructing execution of a transaction. In yet another aspect, a model management system can determine model accuracy of a risk predictive model responsive to detecting an occurrence of changing conditions and/or new events. The embodiments disclosed herein attempt to solve the aforementioned problems and other problems.

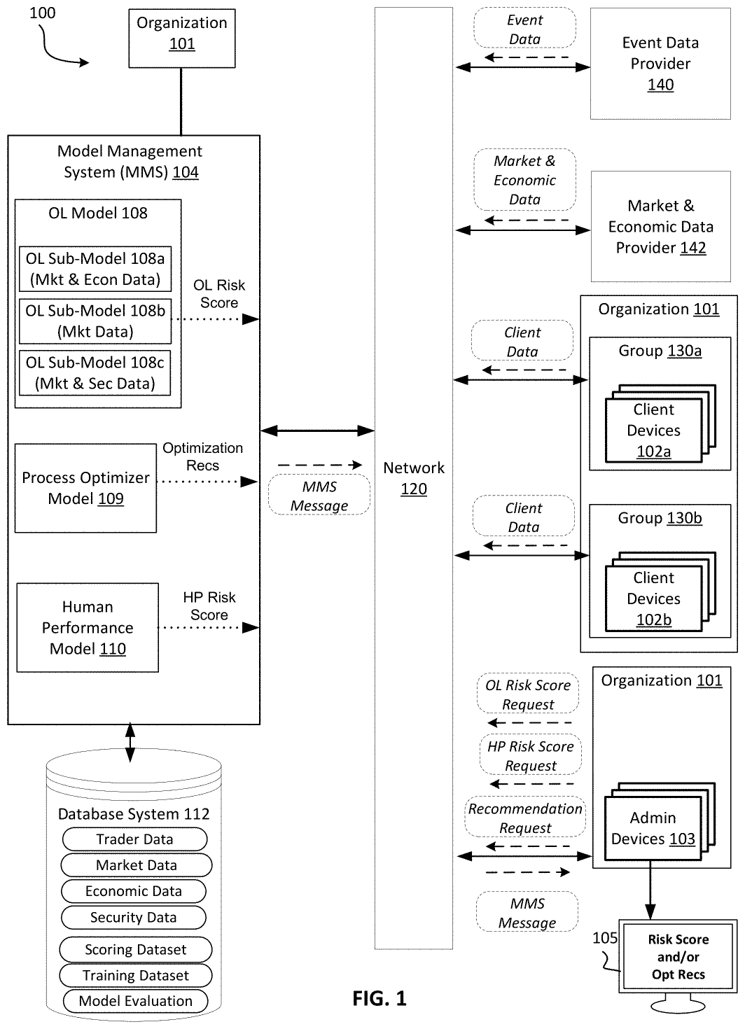

As described in the below passages and specifically in the description of FIG. 1, an organization (e.g., organization 101 in FIG. 1, such as a capital trading group, a financial institution, an investment bank, a broker, a healthcare group, a retail group, a government group, etc.) may manage a plurality of users that are each using a respective client device (e.g., client devices 102a, 102b in FIG. 1) to conduct transactions (e.g., a financial transaction, a capital market trade, a retail transaction, a healthcare transaction, etc.) in a primary and/or secondary market. Each of the users may be assigned to a particular group and/or department (e.g., group 130a, 130b in FIG. 1) within the organization, such that users (sometimes referred to as, “actors”) from a specific group can execute transactions in a market and/or business sector (e.g., healthcare, financial, government, retail, etc.) that is different from the types of transactions that are performed by the users of another group. For example, users of one group may execute transactions associated with commodities, while user from another group may execute transactions associated with stock exchange-traded funds (ETFs).

The organization may operate a model management system (e.g., model management system 104 in FIG. 1) that performs a series of operations (e.g., processes, tasks, actions) using one or more predictive models that execute on the model management system. These predictive models may include, for example, an operational loss model (e.g., OL model 108 in FIG. 1), a process optimizer model (process optimizer model 109 in FIG. 1), and/or a user performance model (e.g., user performance model 110 in FIG. 1). Unlike the process optimizer model and the user performance model, the operational loss model may include additional sub-models, referred to as a “first” operational loss sub-model (e.g., OL sub-model 108a in FIG. 1), a “second” operational loss sub-model (e.g., OL sub-model 108b in FIG. 1), and a “third” operational loss sub-model (e.g., OL sub-model 108c in FIG. 1). However, in some embodiments, an operational loss model that does not include any of the sub-models may still perform the same functionality as the “first” operational loss sub-model, the “second” operational loss sub-model, and the “third” operational loss sub-model.

The series of operations that the model management system performs may be categorized into two phases: a “Training Phase” for training the predictive model and a “Management Phase” for managing and/or using the predictive models once trained. During the Training Phase, the model management system trains (e.g., creates, builds, programs, etc.) each of the predictive models using a training dataset that is specifically generated for a predictive model, based on the type of predictive model. The model management system generates each training dataset using data that the model management system acquires (e.g., receives, retrieves, gathers, etc.) from third-party financial data providers (e.g., exchanges, investment banks, brokers, etc.), third-party event data providers (e.g., national weather forecast, health organizations, news organizations, etc.), internal and/or external groups that are responsible for managing the security for the organization, and/or one or more client devices that are operated by the users associated with of the organization. The specific training process for each of the different types of predictive models will now be explained, in turn.

The model management system trains each of the operational loss sub-models using a plurality of training datasets, such that each sub-model generates a respective risk score (e.g., an output prediction, an output signal) that is indicative of a probability for an operational risk event to occur responsive to an execution of a transaction by one or more users associated with the organization. For example, a trained operational loss sub-model may be capable of predicting (to at least to some degree) the likelihood of one or more users associated with an organization making a mistake (e.g., an error, a fault) in instruction an execution of a transaction, such that the transaction does not complete/settle or it completes/settles incorrectly (e.g., incorrect amount, incorrect quantity, incorrect product and/or service, incorrect ownership, etc.). For instance, an employee may enter wrong information associated with a transaction/trade, which may lead to an operational loss when the transaction/trade is executed.

An operational loss may occur when a transaction involves an event (e.g., mistakes made by employees or malfunction within an operating system used by employees) that unnecessarily increases an organization's operating expenses. For instance, an erroneous transaction (e.g., caused by an employee entering the wrong recipient account number) may lead to fines or penalties. In another example, the organization may need to pay the recipient regardless of whether the transferred money (to the wrong recipient) is recovered. In another example, an erroneous transaction may lead to undesired delays. An operational loss indicates that a company's operations and existing procedures to conduct business are more than a desired amount (e.g., not profitable). Using the methods and systems described herein one or more AI models can predict a likelihood of an event giving rise to a potential operational loss (e.g., a trader delaying transmittal of information needed for a trade). One or more computer described in FIG. 1 can then alert the trader (or the trader's manager), such that the likelihood of the event occurring is reduced.

As used herein, an operational loss may occur due to any error whether committed by a user/employee or a process (e.g., whether automated or semi-automated) performed by a computer. In a non-limiting example, an operational loss may occur when a trader (e.g., employee) executes a trade using one or more incorrect transaction attributes. For instance, the trader may input a wrong account number, transaction amount, or date/time. In another example, an employee may communicate an incorrect trade or transaction attribute to the trader. For instance, a trade manager may transmit a message to the trader that includes the wrong account number. In another example, the error may occur because a computing system facilitating the communication between the manager and the trader may malfunction. For instance, an internal messaging computer system may have malfunctioned causing a delay in trading.

The methods and systems described herein can be applied to any procedure performed within an organization. For instance, on any given day, trading desks can execute thousands of trades, followed by risk-mitigating transactions such as hedges or back-to-back trades. Subsequent losses typically happen because of input errors, forgetting to book a trade, or miscommunicating between traders, sales or the client. Using the methods and systems described herein, one or more AI models can predict when losses are likely and can prompt traders to ‘slow their input’ to avoid input errors, or “clear their queue” to ensure all incoming trades are properly executed.

In another example, the financial services industry processes billions of dollars in payments daily. Payments processes are generally prone to user error, such as transposing errors, entering the wrong account/routing number or value, or selecting the wrong currency/beneficiary. Funds sent in error between institutions are not always identified—and may not be required to be returned. The investigation and resolution of payment errors is time-consuming and can lead to poor customer experience and regulatory scrutiny (i.e., operational loss). Using the methods and systems described herein, one or more AI models can predict when user errors are likely to occur and can alert operations personnel (e.g., “slow their input” or “confirm x, y z fields”).

In another example, business email compromise may be one of the most financially damaging financial crimes. These seemingly legitimate emails could take many forms, for example: a known vendor sends an invoice with an updated mailing address, a company CEO asks her assistant to purchase gift cards as employee rewards, and the like. The recipients may take action to instruct a wire payment based on these fraudulent emails. Using their bank's platform or that of a payment provider, the individual may complete a wire payment form, providing the amount, currency and beneficiary, and may initiate the payment to the criminal. The AI models discussed herein can predict periods of heightened risk of business email compromise or invoice fraud and can prompt individuals to verify the legitimacy of the request and the information entered on the form.

The model management system trains the “first” operational loss sub-model using a “first” training dataset that the model management system generates using historical market data and historical economic data. In some embodiments, the model management system generates a “first” training dataset that does not include security data associated with the organization. In some embodiments, the model management system trains an operational loss model (e.g., an operational loss model that does not include a sub-model) with a training dataset that includes historical market data, historical economic data, and security data associated with the organization. A “first” operational loss sub-model that is trained, is capable of generating a risk score based on consuming (e.g., receiving, ingesting) a scoring dataset.

The model management system trains the “second” operational loss sub-model using a “second” training dataset that the model management system generates using historical market data. In some embodiments, the model management system generates a “second” training dataset that does not include historical market data and security data associated with the organization. A “second” operational loss sub-model that is trained, is capable of generating a risk score based on consuming (e.g., receiving, ingesting) a scoring dataset.

The model management system trains the “third” operational loss sub-model using a “third” training dataset that the model management system generates using historical market data and security data associated with the organization. In some embodiments, the model management system generates a “third” training dataset that does not include historical economic data. A “third” operational loss sub-model that is trained, is capable of generating a risk score based on consuming (e.g., receiving, ingesting) a scoring dataset.

In some embodiments, the sub-models of the operational loss model produce risk scores having values that are different from the values of risk scores that are produced by the other sub-models. As such, the risk scores produced by the sub-models of the operational loss model each indicate a probability for an operational risk event to occur, but for different reasons because each of the sub-models were trained with different training datasets.

The model management system trains the process optimizer model using a “fourth” training dataset to generate one or more recommendations for optimizing a process (e.g., procedure, workflow) for facilitating a transaction. If the one or more recommendations are executed by the users associated with the organization, then the risk of an operational risk event occurring is mitigated (e.g., reduced) and/or nullified. The model management system generates the “fourth” training dataset using one or more of historical market data, historical economic data, security data associated with the organization, information indicating a process/procedure for facilitating a transaction for the organization, and/or one or more risk scores that are generated by the operational loss model or its respective operational loss sub-models. A process optimizer model that is trained, is capable of generating a risk score based on consuming (e.g., receiving, ingesting) a scoring dataset.

The model management system trains the user performance model using a “fifth” training dataset to generate a risk score that is indicative of a probability for a user associated with the organization to cause an operational risk event when executing (e.g., making, entering, performing, etc.) a transaction. The user may cause (purposely or inadvertently) the operational risk event at a time when the user has a particular condition or environment, which may be associated with specific attributes. For example, the user may have caused the operational risk event by instructing execution of a transaction when in a particular emotional state (e.g., angry, sad, depressed, stress, etc.), in a particular health state (e.g., sick, sleepy, etc.), at a particular time (e.g., recently returned from a vacation, etc.), and/or at a particular location (e.g., at building of the organization, working remotely from the organization, etc.)

The model management system generates the “fifth” training dataset using one or more of historical personal attributes (e.g., emotional state, health state, personal obligations/conflicts, family obligations/conflicts, business-related obligations/conflicts, etc.) associated with one or more users, historical market data, historical economic data, security data associated with the organization, information indicating a process/procedure for executing a transaction for the organization, and/or one or more risk scores that are generated by the operational loss model or its respective operational loss sub-models. A user performance model that is trained, is capable of generating a risk score based on consuming (e.g., receiving, ingesting) a scoring dataset.

The model management system may deploy (“bring on-line”) the now-trained, predictive models (e.g., the operational loss model and its respective sub-models, the process optimizer model, and the user performance model) into a production environment, such that the predictive models may each be relied on (together or separately/independently) by an administrator of the organization for the purpose of predicting and/or resolving (e.g., mitigating, preventing, etc.) operational loss events in transactions made by the organization. The model management system may deploy one or more of the predictive models into a production environment by executing (e.g., running) one or more of the predictive models on the model management system. The model management system (and its respective predictive models) may be operated/managed by the organization or by another organization (e.g., a data modeling service provider, a cloud service provider).

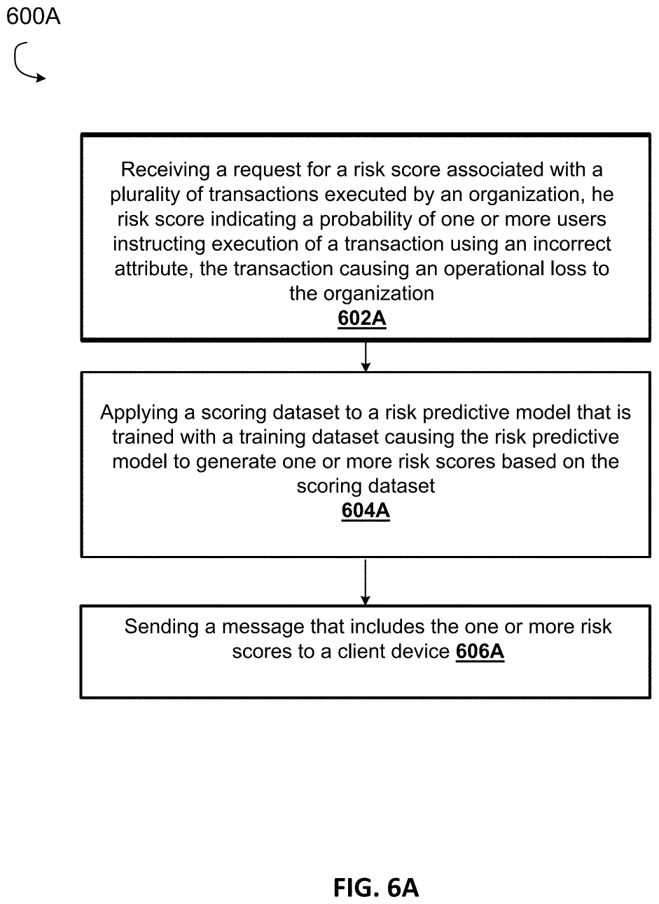

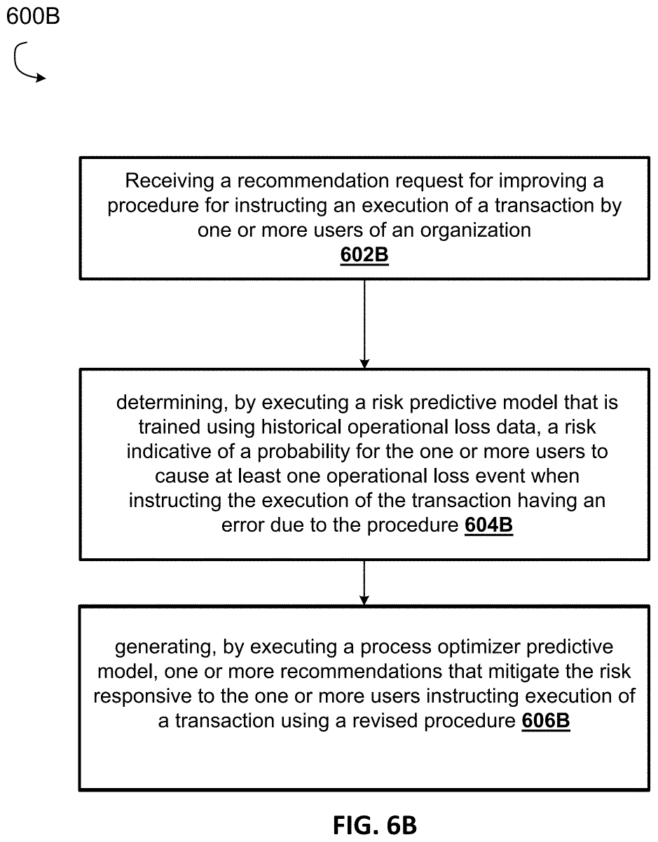

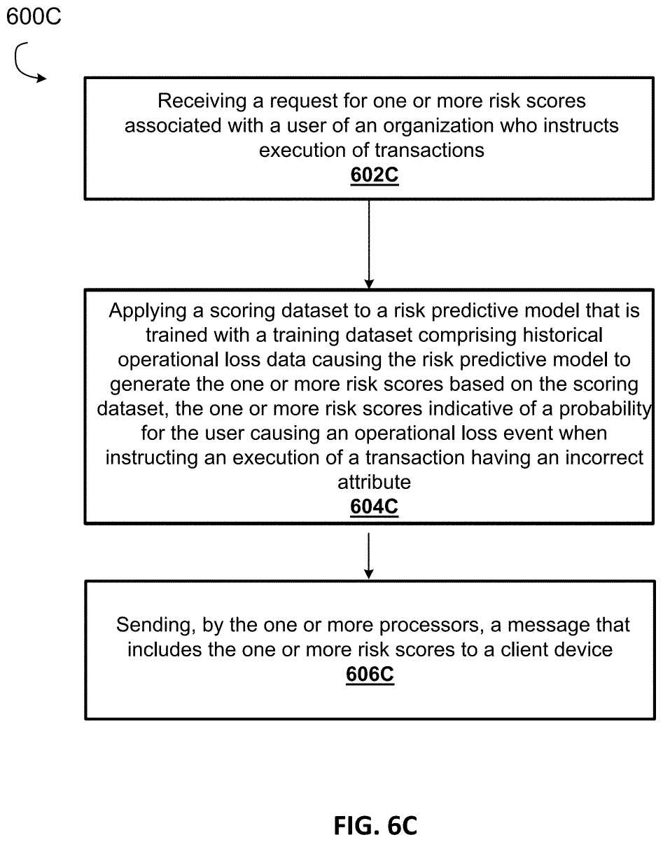

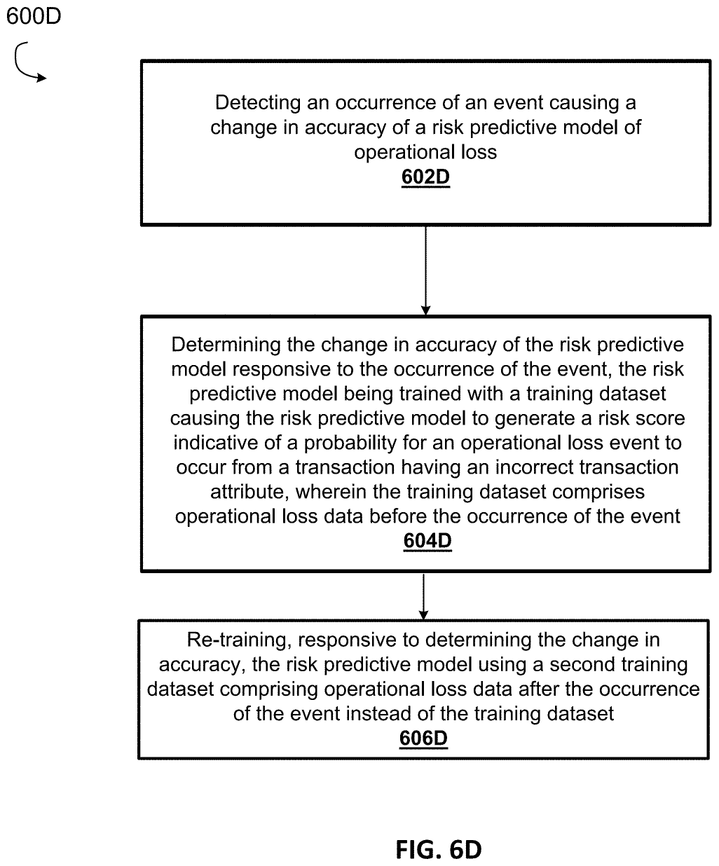

During the Management Phase, the model management system may receive different types of requests to access the features and/or functionality of the deployed (trained) predictive models. The different types of requests will now be explained with reference to FIGS. 6A to 6D.

Using the methods and systems described herein, the model management system may identify a likelihood of operation loss (e.g., due to human error). The system may then notify one or more users accordingly and/or revise a process to reduce the likelihood of an operational loss. As used herein, user error refers to any mistake made by a user (e.g., employee) during a process, such as a trader inputting wrong trade data (e.g., inputting a wrong account number). At work, employees may make user errors when executing manual steps in processes. These often take the form of input errors, missed execution, and miscommunication. Distraction, pace and muscle memory may be among the major contributing factors to user errors.

Given the myriad factors influencing user behavior, and the cost and complexity of operations, the model management system may focus on both the user data and the process data. The system may train one or more predictive models to find the factors that collectively contribute to a higher likelihood of user error and operational loss. By targeting areas of the business where user error is common, instead of focusing on all areas, the system can increase return on investment by reducing the risk of operational loss. To do this, the system may first predict when an error is likely and then provide a specific prompt to the user to offset the behavior that leads to an error or gives rise to an operational loss. For example, to prevent input errors, the system may prompt the user to ‘slow your input.’

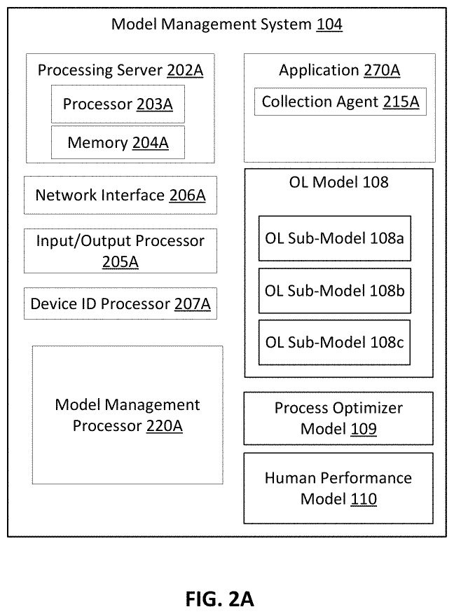

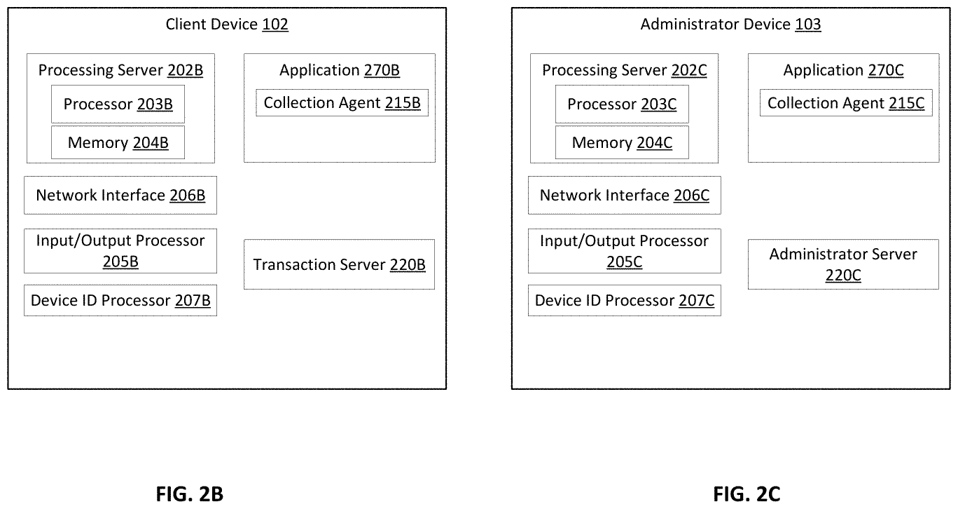

FIG. 6A is a flow diagram depicting a method for using artificial intelligence modeling to determine the probability for an operational loss event to occur responsive to an execution of a transaction by an organization, according to some embodiments. Additional, fewer, or different operations may be performed in the method depending on the particular arrangement. In some arrangements, some or all operations of method 600A may be performed by one or more processors (e.g., processor 203A in FIG. 2B), executing on one or more computing devices, systems, or servers. In some arrangements, some or all operations of method 600A may be performed by one or more model management systems, such as model management system 104 in FIG. 1. In some arrangements, some or all operations of method 600A may be performed by one or more client devices, such as client devices 102 in FIG. 1. In some arrangements, some or all operations of method 600A may be performed by one or more notification systems, such as administrator devices 103 in FIG. 1. Each operation may be re-ordered, added, removed, or repeated.

In a first instance, the model management system may receive a request (sometimes referred to as a “operational loss risk score request” or “OL risk score request”) from an application (e.g., a web browser application, a custom software application, a software development kit (SDK)) executing on a computing device (e.g., administrator device 103 in FIG. 1) associated with an administrator of the organization, as shown in operation 602A of method 600A (receiving, by one or more processors, a request for a risk score associated with a plurality of transactions executed by an organization, the risk score indicating a probability of one or more users instructing execution of a transaction using an incorrect transaction attribute, the transaction causing an operational loss to the organization). The OL risk score request is a request for a risk score that indicates a probability for an operational loss event to occur responsive to a transaction by one or more of the users (e.g., humans using client devices 102a and/or client devices 102b in FIG. 1) of the organization.

In some embodiments, the request may include an identifier to a predetermined window of time, thereby indicating to the model management system that the risk score should indicate the probability for the operational loss event to occur within the predetermined temporal window (e.g., 24 hours from receiving the request). The request may include one or more identifiers (e.g., administrator identifier, organization identifier, group identifier, client identifier, user identifier, etc.).

In response to receiving the request, the model management system may generate a “first” scoring dataset for the “first” operational loss sub-model (e.g., OL sub-model 108a in FIG. 1) using new market data, new economic data, and/or any portion of the OL risk score request. The new market data and the new economic data, in some embodiments, do not appear in the training dataset that the model management system used to train the “first” operational loss sub-model prior to deployment into a production environment.

The model management system applies (e.g., inserts) the “first” scoring dataset to the “first” operational loss sub-model, to cause the “first” operational loss sub-model to generate a risk score indicative of a probability for an operational loss event to occur responsive to a transaction by one or more of the users of the organization, as shown in operation 604A of method 600A (applying, by the one or more processors, a scoring dataset to a risk predictive model that is trained with a training dataset causing the risk predictive model to generate one or more risk scores based on the scoring dataset).

In response to receiving the request, the model management system may generate a “second” scoring dataset for the “second” operational loss sub-model (e.g., OL sub-model 108b in FIG. 1) using new market data and/or any portion of the OL risk score request. The new market data, in some embodiments, does not appear in the training dataset that the model management system used to train the “second” operational loss sub-model prior to deployment into a production environment.

The model management system applies the “second” scoring dataset to the “second” operational loss sub-model, to cause the “second” operational loss sub-model to generate a risk score indicative of a probability for an operational loss event to occur responsive to a transaction by one or more of the users of the organization, as shown in operation 604A of method 600A (applying, by the one or more processors, a scoring dataset to a risk predictive model that is trained with a training dataset causing the risk predictive model to generate one or more risk scores based on the scoring data).

In response to receiving the request, the model management system may generate a “third” scoring dataset for the “third” operational loss sub-model (e.g., OL sub-model 108c in FIG. 1) using new market data, new security data associated with the organization, and/or any portion of the OL risk score request. The new market data and the new security data, in some embodiments, do not appear in the training dataset that the model management system used to train the “third” operational loss sub-model prior to deployment into a production environment.

The model management system applies the “third” scoring dataset to the “third” operational loss sub-model, to cause the “third” operational loss sub-model to generate a risk score indicative of a probability for an operational loss event to occur responsive to a transaction by one or more of users of an organization, as shown in operation 604A of method 600A (applying, by the one or more processors, a scoring dataset to a risk predictive model that is trained with a training dataset causing the risk predictive model to generate one or more risk scores based on the scoring data).

In response to receiving the risk scores from the operational loss model (and/or one or more of the operational loss sub-models), the model management system may send a message (sometimes referred to as, “MMS message”) to the administrator device where the messages causes the administrator device to present the one or more risk scores on a display of the administrator device (e.g., in a graphical user interface), as shown in operation 606A of method 600A (sending, by the one or more processors, a message that includes the one or more risk scores to a client device). In some embodiments, the message causes the administrator device to send a notification message to a client device (e.g., another computing device) to cause the client device to present the one or more risk scores on a display of the client device (e.g., in a graphical user interface).

FIG. 6C is a flow diagram depicting a method for using artificial intelligence modeling to generate recommendations for mitigating the risk associated with one or more employees executing transactions, according to some embodiments. Additional, fewer, or different operations may be performed in the method depending on the particular arrangement. In some arrangements, some or all operations of method 600C may be performed by one or more processors (e.g., processor 203A in FIG. 2B) executing on one or more computing devices, systems, or servers. In some arrangements, some or all operations of method 600C may be performed by one or more model management systems, such as model management system 104 in FIG. 1. In some arrangements, some or all operations of method 600C may be performed by one or more client devices, such as client devices 102 in FIG. 1. In some arrangements, some or all operations of method 600C may be performed by one or more notification systems, such as administrator devices 103 in FIG. 1. Each operation may be re-ordered, added, removed, or repeated.

As described herein, an employee refers to any user who is involved in the overall process being evaluated by the one or more predictive models discussed herein. For instance, an employee may refer to a trader who is instructed to conduct a transaction. Therefore, employee, as used herein does account for an employment status of the user involved in the process. The present disclosure uses user and employee interchangeably.

In a second instance, the model management system may receive a request (sometimes referred to as a “user performance risk score request” or “HP risk score request”) from an application (e.g., a web browser application, a custom software application, a software development kit (SDK)) executing on a computing device (e.g., administrator device 103 in FIG. 1) associated with an administrator of the organization, as shown in operation 602C of method 600C (receiving, by one or more processors, a request for one or more risk scores associated with a user of an organization who instructs execution of transactions). The HP risk score request is a request for a risk score that indicates a probability for a user (e.g., user using client devices 102a and/or client devices 102b in FIG. 1) to cause an operational loss event related to wrongful or erroneous execution of a transaction.

In some embodiments, the risk score request may include an identifier to a predetermined temporal window, thereby indicating to the model management system that the risk score should indicate the probability for the operational loss event to occur within the predetermined temporal window (as discussed herein). The request may include one or more identifiers (e.g., administrator identifier, organization identifier, group identifier, user identifier, etc.).

In response to receiving the request, the model management system may generate a scoring dataset for the user performance model (e.g., user performance model 110 in FIG. 1) using personal (new or historical) attributes of the user executing the transaction, new market data, new economic data, new security data, and/or any portion of the OL risk score request. The new market data, the new economic data, and the new security data, in some embodiments, do not appear in the training dataset that the model management system used to train the user performance model prior to deployment into a production environment.

The model management system applies the scoring dataset to the user performance model, to cause the user performance model to generate a risk score indicative of a probability for the user (e.g., users using client devices 102a and/or client devices 102b in FIG. 1) to cause an operational loss event when instructing execution of a transaction, as shown in operation 604C of method 600C (applying, by the one or more processors, a scoring dataset to a risk predictive model that is trained with a training dataset comprising historical operational loss data causing the risk predictive model to generate the one or more risk scores based on the scoring dataset, the one or more risk scores indicative of a probability for the user causing an operational loss event when instructing an execution of a transaction having an incorrect transaction attribute).

In response to receiving the risk scores from the user performance model, the model management system may send a message (sometimes referred to as, “MMS message”) to the administrator device where the messages causes the administrator device to present the one or more risk scores on a display of the administrator device (e.g., in a graphical user interface), as shown in operation 606C of method 600C (sending, by the one or more processors to a client device, a message that includes the one or more risk scores to a client device). In some embodiments, the message causes the administrator device to send a notification message to a client device to cause the client device to present the one or more risk scores on a display of the client device (e.g., in a graphical user interface).

In some embodiments, the system may compare the score/risk generated using the predictive models against predetermined thresholds and may transmit notifications to one or more computers when the score/risk satisfies a threshold. For instance, when an employee is predicted to make an error (the employee's likelihood of making a mistake is higher than a predetermined amount), the system may notify the employee and/or the employee's supervisor.

FIG. 6B is a flow diagram depicting a method for using artificial intelligence modeling to determine the probability for one or more users of an organization to cause an operational loss event when instructing execution of a transaction, according to some embodiments. Additional, fewer, or different operations may be performed in the method depending on the particular arrangement. In some arrangements, some or all operations of method 600B may be performed by one or more processors (e.g., processor 203A in FIG. 2B) executing on one or more computing devices, systems, or servers. In some arrangements, some or all operations of method 600B may be performed by one or more model management systems, such as model management system 104 in FIG. 1. In some arrangements, some or all operations of method 600B may be performed by one or more client devices, such as client devices 102 in FIG. 1. In some arrangements, some or all operations of method 600B may be performed by one or more notification systems, such as administrator devices 103 in FIG. 1. Each operation may be re-ordered, added, removed, or repeated.

In a third instance, the model management system may receive a recommendation request from an application (e.g., a web browser application, a custom software application, a software development kit (SDK)) executing on a computing device (e.g., administrator device 103 in FIG. 1) associated with an administrator of the organization, as shown in operation 602B of method 600B (receiving, by one or more processors, a recommendation request for improving a procedure for instructing an execution of a transaction by one or more users of an organization). The recommendation request is a request for one or more recommendations for improving a procedure for transactions by the organization.

In some embodiments, the recommendation request may include an identifier to a predetermined window of time, thereby indicating to the model management system that the one or more recommendations should be for improving a procedure for transactions by the organization that take place within the predetermined temporal window. The recommendation request may include one or more identifiers (e.g., administrator identifier, organization identifier, group identifier, user identifier, client identifier, user identifier, trader identifier, etc.).

In response to receiving the request, the model management system may, in some embodiments, cause the operational loss model (and its respective sub-modules), and/or the user performance model to determine and produce their respective risk scores, as shown in operation 604B of method 600B (determining, by the one or more processors executing a risk predictive model that is trained using historical operational loss data, a risk indicative of a probability for the one or more users to cause at least one operational loss event when instructing the execution of the transaction having an error due to the procedure). In response to receiving the request, the model management system may generate a scoring dataset for the process optimizer model (e.g., process optimizer model 109 in FIG. 1) using one or more of new market data, new economic data, new security data associated with the organization, information indicating a process/procedure for executing a transaction for the organization, personal attributes of one or more users, one or more risk scores that are generated by the operational loss model or its respective operational loss sub-models, and/or any portion of the recommendation request.

The model management system applies the scoring dataset to the process optimizer model, to cause the process optimizer model to generate one or more recommendations that mitigate the risk of an operational loss event occurring responsive to the one or more users executing the one or more recommendations, as shown in operation 606B of method 600B (generating, by the one or more processors executing a process optimizer predictive model, one or more recommendations that mitigate the risk responsive to the one or more users instructing execution of a transaction using a revised procedure). For example, the process optimizer model could determine that an ETF trade is more complicated to execute than a commodity trade, and that most users (or a particular human) are less likely to make execution errors at the beginning of their shift. As such, the process optimizer model could generate a recommendation that instructs the user to perform ETF trades in the beginning of the user's shift and commodity trades toward the end of the shift, in order to lessen the likelihood for a user to make a trading error.

In response to receiving the recommendations from the process optimizer model, the model management system may send a message (sometimes referred to as, “MMS message”) to the administrator device where the messages causes the administrator device to present the one or more risk scores and/or the recommendations on a display of the administrator device (e.g., in a graphical user interface). In some embodiments, the message causes the administrator device to send a notification message to a client device (e.g., another computing device) to cause the client device to present the recommendations on a display of the client device (e.g., in a graphical user interface).

In a non-limiting example, an end user requests the model management system to optimize a process. For instance, an end user may identify a user employee (e.g., trader) and a trade to be performed by a trader. The end user may then request the model management system to optimize the process (also referred to herein as procedure) of the trade. The model management system may execute one or more of the risk predictive models discussed herein to identify a risk of operational loss. For instance, the model management system may identify a likelihood associated with the trader to make a mistake executing the trade via the procedure (e.g., procedure identified via the end user or the procedure usually executed by traders to execute the trade). When the model management system identifies that the risk satisfies a threshold (e.g., beyond a predetermined amount), the model management system may also execute a process optimizer model (process optimizer model 110 in FIG. 1). The process optimizer model may generate one or more recommendations to minimize the risk of operational loss.

In some embodiments, the model management system may automatically and periodically monitor one or more procedures to generate recommendations accordingly. For instance, the model management system may periodically (and automatically, such as without being instructed by an end user) monitor actions performed within an organization. For instance, the model management system may monitor instructions transmitted to different traders (e.g., trade orders received by traders). The model management system may then execute one or more models discussed herein to determine if there is a risk of operational loss. If the risk is higher than a predetermined threshold, the model management system may then generate and output one or more recommendations accordingly. In some embodiments, the recommendations may be automatically executed.

In a non-limiting example, using the methods and systems described herein, the system can identify days when specific lines of business have a higher likelihood of user error. The system may then alert specific employees to change their behavior to avoid an input error, missed execution and/or miscommunication. For instance, if a manager instructs a trader to conduct a trade, the manager may receive a prompt informing the manager that the manger must double check the trade or transaction attributes inputted by the trader. In another embodiment, the trade may be re-routed to another trader (e.g., from another line of business).

In another non-limiting example, using the methods and system described herein, the system can also monitor and/or revise various processes that are predicted to lead to an error or operational loss. The system may make a targeted change to a process, using machine learning to identify when those processes have a higher likelihood of user error. The system may then either change the process or automate the process. For instance, if the one or more predictive models determine that user error increases when the volume of transactions are above a certain threshold, the system may adjust the process to automatically redirect transactions to other employees. The system can also identify which employees might have capacity to ensure that the redirected transactions can be absorbed. For instance, when a manager instructs a trader to execute a transaction/trade, the system may prompt the manager to instruct other traders or otherwise allocate the workload to other employees. In some embodiments, when the risk of operational loss is higher than a threshold, the system may delay the transaction/trade (if authorized).

In another example, if the system can identify what parts of, or types of, process are likely to have an error (and their corresponding days), the system can automate at least a part of the process. For example, some processes require a user to re-input or re-key information, but not all re-keying results in user error. Determining the factors that lead to re-keying errors in one process and not another allows the system to automate certain parts of the process. For instance, the system can auto-populate certain information where the information is predicted to cause an operational loss more than a predetermined threshold.

In another example, the system may reduce monitoring and reporting one or more processes. For example, the system may use risk assessments, key risk indicators, monitoring and testing to identify and report risk of user error. However, if the system determines that user error is likely in specific lines of businesses and not in others, then the system can eliminate the execution or frequency of the processes where the risk is low. This enables businesses to align risk processes with where the risk is. For instance, if a part of the procedure of conducting a trade (e.g., inputting an account number) is frequently identified as having risk of operational loss that is higher than a certain amount, the system may increase a frequency of monitoring whether that part of the procedure is correctly performed. In contrast, if a part is identified as less risky (e.g., below a threshold), the system may decrease the frequency with which that part is monitored.

FIG. 6D is a flow diagram depicting a method for using artificial intelligence modeling to determine model accuracy of a risk predictive model responsive to detecting an occurrence of changing conditions and/or new events, according to some embodiments. Additional, fewer, or different operations may be performed in the method depending on the particular arrangement. In some arrangements, some or all operations of method 600D may be performed by one or more processors executing on one or more computing devices, systems, or servers. In some arrangements, some or all operations of method 600D may be performed by one or more model management systems, such as model management system 104 in FIG. 1. In some arrangements, some or all operations of method 600D may be performed by one or more client devices, such as client devices 102 in FIG. 1. In some arrangements, some or all operations of method 600D may be performed by one or more notification systems, such as administrator devices 103 in FIG. 1. Each operation may be re-ordered, added, removed, or repeated.

### NON-LIMITING EXAMPLE

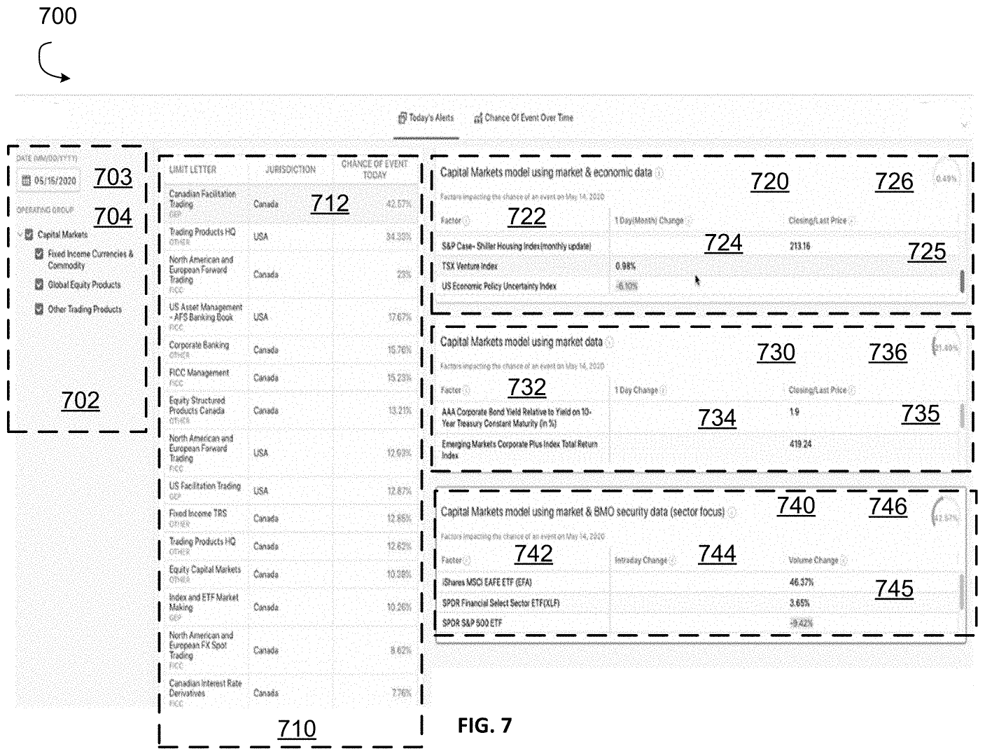

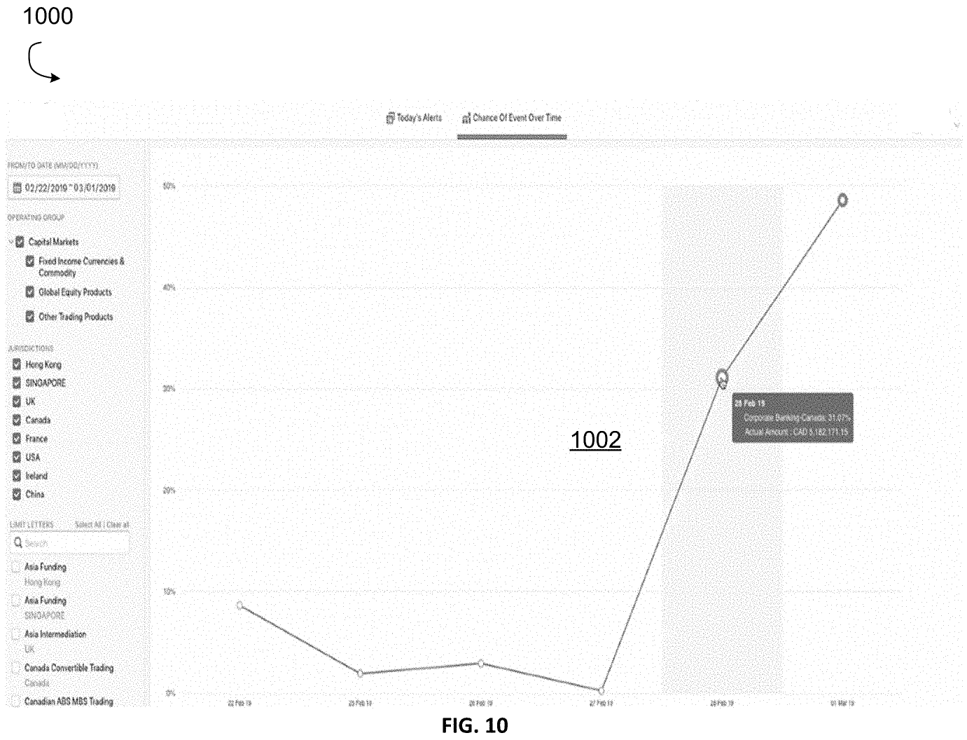

The model management system may provide a GUI, such as the GUIs depicted in FIGS. 7-10. An end user may use one or more input elements of these GUIs to instruct the model management system to identify a likelihood of operational loss based on user error. Using the method described in FIG. 6D, the model management system may use one or more models to identify the requested likelihood based on attributes of a trader (e.g., personal attributes). For instance, the system may analyze market factor (e.g., microeconomic factors and macroeconomic factors) using any of the sub-models discussed herein. Additionally or alternatively, the system may use the user performance model to analyze a particular trader's behavior. As described herein, the user performance model is trained based on user attributes (e.g., demographic factors, such as age, sex, education level), work related attributes (e.g., number of paid time away from work taken, when the time off was taken by the employee, medical leave (if any)). The model may also analyze other data, such as holidays (e.g., certain employees are more likely to make mistakes after a long weekend or after an extended break from work).

The model management system may then calculate a likelihood of operational loss caused by an employee (e.g., trader). For instance, when a trader comes back from a week-long vacation, the trader may be more likely to make a mistake.

In some configurations, the model management system may be required to update one or more models described herein, such that at least one model is configured for a new client or a new set of data. As described in FIG. 1, the model management system ingests data from various data sources (e.g., data tables, such as event data provider 140 and market and economic data provider 142). These data tables (also referred to herein as data providers) may be updated in real time (or periodically), such that data is pushed to or pulled by the model management system (e.g., servers and processors executing the models described herein). This architecture allows the model management system to ingest different data in segments, such that one or more data feeds can be replaced/revised without affecting other data feeds. For instance, while the model management system is operational (e.g., while the model management system is ingesting data from at least one data source and predicting the results described herein), one or more data sources can be updated, added, and/or removed. Therefore, a system administrator can add a new data table or change/reconfigure the data within one or more data tables without disrupting the model management system.

The data ingested by the model management system may also include client-specific or organization-specific data, such as security data or group data. The client-specific or organization-specific data may include proprietary client/user data or other data that is specific to each client/user (e.g., end user receiving the results). Non-limiting examples of client-specific or organization-specific data may include previous transactions performed by one or more users and their corresponding user attributes, various internal rules and thresholds mandating different actions, and the like.

In a non-limiting example, a client (e.g., user of the organization, an end-user) may populate one or more tables with propriety data that can then be ingested by the model management system. As a result, the model management system may use the methods and systems described herein to train one or more models using client-specific or organization-specific data. As a result, the model management system may generate results (e.g., prediction of an event, such as a likelihood of a mismanaged trade) that only apply to the client.

However, the model management system can be reconfigured, such that results are generated for multiple clients/organization without sharing any priority data among different clients. For instance, the model management system may be reconfigured for multiple users/clients where each client/user can receive results that are tailored towards that client/user. The model management system may map one or more data tables to a specific client where the model management server ingests data from the mapped data tables only when the model management server generates results for that particular client. I n this way, the model management system may simultaneously provide services to multiple clients without any service disruptions or inappropriate sharing of data.

The model management system can adapt the one or more predictive models to changing conditions and/or new events. That is, the model management system can detect the occurrence of a new event (e.g., a health-related pandemic, a new client relying on the predictive models), as shown in operation 602D of method 600D (detecting, by one or more processors, an occurrence of an event corresponding to data that is inconsistent with one or more data records within a training dataset used to train a risk predictive model). The model management system can predict the likelihood for the accuracy of the predictive model to change as a result of the new event, as shown in operation 604D of method 600D (determining, by the one or more processors, a change in accuracy of a risk predictive model responsive to the occurrence of the event having at least one incorrect transaction attribute). The model management system can then autonomously re-train the predictive model using a new training dataset that is different from the training dataset that was used to deploy the predictive model into a production environment, in order to improve and maintain the predictive model's accuracy, as shown in operation 606D of method 600D (re-train, the one or more processors responsive to determining the change in accuracy, the risk predictive model using a second training dataset that is different than the training dataset).

The new event or changing condition may refer to a new unpredicted factor (e.g., environment, corporate strategy) that may affect other data (e.g., a pandemic that could affect trading and market data for a period of time) or may be client-specific data. As a result of the event occurring, one or more data records within the training dataset used to train the risk predictive model may no longer apply. For instance, because of the event, users may be forced to work remotely. Therefore, patterns and attributes giving rise to errors and operational loss events may be different (users working from the office may make different mistakes that workers working remotely). As a result, the event may correspond to data that is inconsistent with one or more data records within the training dataset.

The second training dataset may be received from a client device. For instance, a client may populate a data table with proprietary data and instruct the model management server to reconfigure itself, such that the predicted results also account for the newly populated proprietary data. In some configurations, the end user may access a platform of the system to indicate occurrence of the event. For instance, the end user may indicate that the predictive model(s) may need to be re-evaluated due to the event.

Thus, a model management system may train and manage a plurality of predictive models (e.g., an operational loss model and its respective sub-models, a process optimizer model, and a user performance model) that may be relied on by an administrator of an organization for the purpose of predicting and/or resolving (e.g., mitigating, preventing, etc.) operational loss events in transaction by the organization.

In a non-limiting example, an end user may utilize a client computing device to indicate that an event has occurred that could potentially change the predictive model(s) accuracy. For instance, the end user may indicate that employees are now working from home due to a global pandemic, which may change how operational loss likelihoods are calculated. The end user may upload a new training dataset that comprises market data, security data, and/or trade data starting from the occurrence of the event (start of the pandemic). The system may then map the data records within the uploaded new training dataset to their corresponding data record within the original dataset. The system may then replace the old data record with their corresponding new data records and may retrain one or more of the predictive models, such that when generating predictions, the models use the newly receive training data.

In another non-limiting example, the model management system may be trained to predict event data (e.g., trade misappropriation) for two clients. Each client may utilize a server to transmit an instruction to the model management server to periodically update a dashboard (e.g., dashboard depicted in FIG. 7-10). The model management server maps appropriate data tables for each client where the data from the data tables are ingested by the one or more models to generate predictions for each client using only the mapped data tables. When the first client adds a new data table that populates proprietary data, the model management server revises the mapped data tables and includes the newly added client-specific data without disrupting the services provided to either client. When the model management server receives the next request from the first client, the model management system ensures that data from the newly added data table is also ingested by the artificial intelligence models described herein. Additionally or alternatively, the model management system may retrain the model using the newly added data table. As a result, even though the same model is executed, results for the first and the second client may be different.

In another non-limiting example, the model management system may ingest data associated with an organization to identify a risk of loss associated with one or more departments within the organization using one or more predictive models discussed herein. Upon reviewing the results generated by the predictive model(s), the system or the end user may determine that the predictive model(s) do not produce results that are accurate within a tolerable threshold. The newly discovered inaccuracy may be caused by new conditions. For instance, a pandemic may have forced employees to work remotely, which may have contributed to a new set of underlying reasons and conditions giving rise to new operational losses (e.g., new ways of making errors). Therefore, the predictive model, which was previously producing accurate results, may no longer product accurate results in light of the new conditions.

To rectify the above-described problem, the system add or replace a set of data within the training data, such that one or more predictive models can adapt to the new circumstances. For instance, a new set of trading data can be added to the training data and the predictive model(s) can be retrained accordingly. In another example, the system may monitor traders and generate a new dataset. The system may then re-train the predictive model(s) accordingly.

### 1. Environment for Predicting Operational Loss Events

FIG. 1 is a block diagram depicting an example environment for predicting operational loss events in transactions using artificial intelligence modeling, according to some embodiments. The environment 100 includes a model management system 104 that is operated and/or managed by an organization 101 (such as a capital-trading group, a financial institution, an investment bank, a broker, etc.) and configured to train and/or manage one or more predictive models.

The environment 100 includes a database system 112 that is communicably coupled to the model management system 104 for storing client data associated with one or more client devices 102a, 102b (collectively referred to as, “client devices 102”), market data, economic data, security data, scoring datasets, training datasets, and metrics (e.g., concept drift, false positives, true positives, recall (sensitivity), model accuracy, etc.) related to model evaluation. The model management system 104 may populate the database system 112 using information that is received (e.g., acquired, gathered, collected) by the organization 101 and/or any other organization (e.g., event data provider 140, market & economic data provider 142, etc.). This information may be periodically (or in real-time) pushed to the model management system 104. In some embodiments, the model management system 104 may send requests to one or more of the devices and/or providers (e.g., client device 102a, 102b, event data provider 140, market & economic data provider 142) that causes the devices and/or providers to send back their respective data to the model management system 104.

The environment 100 includes an event data provider 140 that is in communication with the model management system 104 via a network 120. The event data provider 140 provides event data to the model management system 104. The model management system 104, responsive to receiving the event data, may store the event data in the database system 112. The event data provider 140 may include, for example, news organizations, national weather organizations, medical and/or health organizations, publishers, local and/or federal departments and/or agencies, etc. The event data may include health data and/or health-related pandemic data (e.g., COVID-19, flu, etc.), local news, national news, foreign news, calendar events (e.g., holidays), weather data, publications, customer data, data indicating that a new customer is relying on model management system 104 in FIG. 1, casualty and/or disaster information, etc.

The environment 100 includes a market & economic data provider 142 that is in communication with the model management system 104 via the network 120. The market & economic data provider 142 provides market data and/or economic data to the model management system 104. The market & economic data provider 142 may be two separate entities: a market data provider and an economic data provider, or both entities may be the same entity capable of providing both market data and economic data. The model management system 104, responsive to receiving the market data and/or economic data, may store the market data and/or economic data in the database system 112.

The market data provider of the market & economic data provider 142 may include, for example, a trading exchange, a trading venue, a financial data vendor. The market data may include price and trade-related data for a financial instrument reported by a trading venue such as a stock exchange. Market data may allow users (e.g., traders, investors) to know the latest price and see historical trends for instruments such as equities, fixed-income products, derivatives, and currencies. The market data for a particular instrument may include the identifier of the instrument and where it was traded such as the ticker symbol and exchange code plus the latest bid and ask price and the time of the last trade. It may also include other information such as volume traded, bid, and offer sizes and static data about the financial instrument that may have come from a variety of sources. The market data may be real-time (e.g., current) or delayed (e.g., historical) price quotations for the financial instrument.

A financial instrument is a monetary contract between parties. It can be created, traded, modified and settled. A financial instrument can be cash (e.g., currency), evidence of an ownership interest in an entity or a contractual right to receive or deliver (e.g., currency; debt: bonds, loans; equity: shares; derivatives: options, futures, forwards, etc.).

The economic data provider of the market & economic data provider 142 may include, for example, official organizations such as statistical institutes, intergovernmental organizations such as United Nations, European Union or Organization for Economic Co-operation and Development (OECD), central banks, Bureau of Economic Analysis (BEA) of the United States Department of Commerce, ministries, etc.

The economic data (sometimes referred to as, “economic statistics”) is data and/or quantitative measures describing an actual economy, past or present. These are typically found in time-series form, that is, covering more than one time period (e.g., the monthly unemployment rate for the last five years) or in cross-sectional data in one time period (e.g., for consumption and income levels for sample households). The economic data may also be collected from surveys of for example individuals and firms or aggregated to sectors and industries of a single economy or for the international economy. The economic data may also include Gross National Product and its components, Gross National Expenditure, Gross National Income in the National Income and Product Accounts, and the capital stock and national wealth. In these examples, the data may be stated in nominal or real values, that is, in money or inflation-adjusted terms. Other economic indicators include a variety of alternative measures of output, orders, trade, the labor force, confidence, prices, and financial series (e.g., money and interest rates). At the international level there are many series including international trade, international financial flows, direct investment flows (between countries) and exchange rates.

In addition to analyzing employee-specific attributes (e.g., emotions, health state, location), the model may also be trained on particular holidays. For instance, the model may determine that employees are more prone to make mistakes the day after an important sporting event or a holiday (e.g., Christmas).

The environment 100 includes one or more client devices 102a, 102b (collectively referred to as, “client devices 102”) that are associated with group 130a of organization 101. A group may be group or department of an organization including, but not limited to, an operation department, a risk management department, a shared services department, a user resource department, a customer service department, a financial and/or trading department, a supply chain department, or an information technology department.

The environment 100 includes one or more client devices 102b that are associated with a group 130b of organization 101. The client devices 102a, 102b (collectively referred to as, “client devices 102”) are in communication with the model management system 104 and/or administrator device 103 (shown in FIG. 1 as, “admin devices 103”) via the network 120. The client devices 102a are configured to execute one or more transactions (e.g., trades, agreements) of a “first” plurality of transaction types (e.g., financial instruments, government contracts, healthcare contracts) using a primary or secondary market. The client devices 102b are configured to execute one or more transactions of a “second” plurality of transaction types using the primary or secondary market. In some embodiments, the transaction of a “first” plurality of transaction types are different than the transactions of a “second” plurality of transaction types. For example, client devices 102a may only transact (trade) in ETFs when associated with group 130a, and client devices 102b may only transact (trade) in bonds when associated with group 130b. A transaction type may include one or more of ETFs, stocks, bonds, commodities, capital market trades, financial instruments, cryptocurrency, real estate, derivatives, government contracts, healthcare products, etc.

The client devices 102a, 102b may be configured to autonomously (e.g., freely, without request, etc.) provide data (sometimes referred to as, “client data,” “personal data”) associated with the client device and/or the user operating the client device. This data sharing feature of the client devices 102a, 102b allows the model management system 104 to monitor (e.g., track, trace) the performance of the client device 102 and/or the user of the client device 102. The model management system 104, responsive to receiving the client data, may store the client data in the database system 112. The client data may include, for example, transaction data (e.g., transactions performed by the client device), voice and/or visual data associated with the user, data in the device storage, calendar and/or email data associated with the user, client device identifier, any data intercepted by an input/output processor (e.g., input/output processor 205B in FIG. 2B) of the client device 102.

The model management system 104 includes an operational loss model 108 (shown in FIG. 1 as, “OL model 108) that includes an operational loss sub-model 108a (shown in FIG. 1 as, “OL sub-model 108a) that is trained to generate a “first” risk score based on the market data and the economic data. The model management system 104 includes an operational loss sub-model 108b (shown in FIG. 1 as, “OL sub-model 108b) that is trained to generate a “second” risk score based on the market data. The model management system 104 includes an operational loss sub-model 108c (shown in FIG. 1 as, “OL sub-model 108c) that is trained to generate a “third” risk score based on the market data and the security data associated with the organization. Each of the risk scores indicate a probability for an operational loss event to occur responsive to a transaction by one or more of the users (via one or more of the client devices 102a, 102b) of the organization 101.

The model management system 104 includes a process optimizer model 109 that is trained to generate recommendations (shown in FIG. 1 as, “Optimization Recs”) for improving the process for executing transactions. For example, a recommendation may be for users to execute more complicated transactions in the beginning of a user's shift, when the user is more alert. As another example, a recommendation may be for the organization to balance (e.g., diversify, spread, etc.) the number of transactions across a plurality (or all) of locations of the organization to avoid overloading one location of the organization. As another example, the combination of the types of steps and controls in a process and the sequence in which they occur could produce signal indicating that certain combinations increase the likelihood of an operational loss event. As a result, those process steps and controls could be adjusted (e.g., re-ordered, automated, or removed) to enhance the process or increase throughput. As another example, a recommendation may be for the organization 101 to require the users to take periodic breaks during the work shift.

As another example, a recommendation may be for the organization 101 to not permit a user (e.g., employee) to work more than a predetermined number of days in a row. As another example, a recommendation may be to require a user to take a number of days of vacation after experiencing a life event (e.g., a death in the family, a wedding, having a newborn, etc.). As another example, the recommendation may be to re-assign a user from one group (e.g., trading commodities) to another group (e.g., trading bonds).

The process optimizer model 109 may be trained using data associated with previously performed processes. For instance, when an operational loss event is identified, a processor within the system 104 may collect data associated with the operational loss event. The system may then collect data with similar events that did not result in operational losses. For instance, when a trader mistakenly instructs a clear housing server to conduct a transaction (e.g., the trader inputs the wrong account number), data associated with the trader and the operational loss even is collected. For instance, the trader's demographic data and other relevant information, such as the trader's workload (e.g., how many trades performed by the trader, trader's manager, or a division or group of employees that includes the trader).

In another example, the system may also collect data associated with the time of the trade (e.g., when the order was issued and when it was executed and/or how long after receiving the order the trader instructed/executed the transaction) and transaction attributes (e.g., amount of transaction, sender's information, recipient's information, type of trade, type of commodity being traded). The system may also collect similar data associated with trades that did not result in an operational loss. This data may be sometimes performed by the same trader or similar traders (e.g., successful trades performed by the same trader or performed by the same trader under similar time constraints). In some configurations, the data collected may belong to other traders or groups that perform similar trades (e.g., other traders with a similar background or demographic data performing trades or other traders executing trades that are similar to the ones that resulted in operational losses).

In some configurations, the system may collect metadata associated with trades that resulted in operational losses. The metadata may indicate data associated with multiple parts of the process that resulted in the operational loss.

After collecting the data, the system may train the process optimizer model 109 using the collected data. For instance, the collected data may be labeled, such that the process optimizer model 109 can distinguish processes that result in operational losses. After training, the process optimizer model 109 may be able to identify patterns within processes that result in operational losses. For instance, the process optimizer model 109 may be able to predict a threshold associated with a particular trader where when the trader is assigned a number of trades that satisfies the thresholds, the trader is more likely to make a mistake.

The model management system 104 includes a user performance model 110 that is trained to generate a risk score that is indicative of a probability for an individual of the organization 101 executing a step in a process (e.g., users of any one of client devices 102a, 102b) to cause an operational loss event when making (e.g., executing, entering, performing, etc.) a step in a transaction process. The individual, referred to as an actor, may cause (purposely or inadvertently) the operational loss event at a time when specific attributes are associated with the transaction. For example, the actor may have caused the operational loss event by executing a step in a transaction process when in a particular emotional state (e.g., angry, sad, depressed, stress, etc.), in a particular health state (e.g., sick, sleepy, etc.), and/or in a particular location (e.g., at a building of the organization, working remotely from the organization, etc.). When a risk score indicates a high likelihood of undesired behavior (e.g., input error, error in judgement, intentional conduct), the organization may work with the actor to recognize and avoid the behavior. For example, an individual who makes input errors on the day they return from a two-week mandatory leave can be supported on that day through reminders and enhanced controls. As another example, an actor (user) who exceeds transaction limits every time their book performs below targets for two consecutive months could be taught to recognize the behavior and create additional strategies to avoid limit breaches at the same time as improving the performance of a book. As another example, an individual who has demonstrated inappropriate behaviors could be provided feedback prior to those behaviors becoming detrimental to peers or the individual's employment.

The environment 100 includes the administrator device 103 that is operated/managed by an administrator associated with the organization 101. The administrator device 103 is in communication with the model management system 104 and the client devices 102a, 102b via the network 120. The administrator device 103 is configured to execute an application that allows a user (e.g., administrator) of the administrator device 103 to send (via the application) an operational loss risk score request (shown in FIG. 1 as, “OL risk score request”), user performance risk score request (shown in FIG. 1 as, “HP risk score request”), and/or a recommendation request to the model management system 104, and present messages that it receives from the model management system 104 on a display (e.g., computer display 105) and/or send (e.g., forward, redirect) the message to the one or more client devices 102a, 102b to cause the one or more client devices 102a, 102b to present the message on a display of the one or more client devices 102a, 102b.

The environment 100 includes a computer display 105 (e.g., a monitor, a smartphone display) that is communicably coupled to the model management system 104 for displaying information (e.g., one or more risk scores, recommendations, etc.).

Each of the client devices 102, the administrator device 103, and the model management system 104 may be any number of different types of electronic computing devices (also referred to herein as, “computing device” and “electronic device”), including without limitation, a personal computer, a laptop computer, a desktop computer, a mobile computer, a tablet computer, a smart phone, an application server, a catalog server, a communications server, a computing server, a database server, a file server, a game server, a mail server, a media server, a proxy server, a virtual server, a web server, or any other type and form of computing device or combinations of devices.

Although FIG. 1 shows only a select number of computing devices (e.g., model management system 104, client devices 102a,102b, administrator devices 103, computer display 105) and predictive models (e.g., operational loss model 108, OL sub-model 108a, OL sub-model 108b, OL sub-model 108c, process optimizer model 109, user performance model 110); the environment 100 may include any number of computing devices (and predictive models) and/or predictive models that are interconnected in any arrangement to facilitate the exchange of data between the computing devices. The environment 100 may also include any number of groups (e.g., groups 130a, groups 130b, etc.).

In some embodiments, the environment 100 may include a “first” model management system (e.g., MMS 104) that includes and/or executes an operational loss model (e.g., OL model 108); a “second” model management system (e.g., MMS 104) that includes and/or executes a process optimizer model (e.g., process optimizer model 109); and a “third” model management system (e.g., MMS 104) that includes a user performance model (e.g., user performance model 110); thereby allowing each of the models to operate (execute) separately and independently from one another.

### 2. System Architecture for Predicting Operational Loss Events

FIG. 2A is a block diagram depicting an example model management system of the environment in FIG. 1, according to some embodiments. While various servers, interfaces, and logic with particular functionality are shown, it should be understood that the model management system 104 includes any number of processors, servers, interfaces, and logic for facilitating the functions described herein. For example, the activities of multiple servers may be combined as a single server and implemented on a single processing server (e.g., processing server 202A), as additional servers with additional functionality are included.

The model management system 104 (sometimes referred to as, “MMS 104”) includes a processing server 202A composed of one or more processors 203A and a memory 204A. A processor 203A may be implemented as a general-purpose processor, a microprocessor, an Application Specific Integrated Circuit (ASIC), one or more Field Programmable Gate Arrays (FPGAs), a Digital Signal Processor (DSP), a group of processing components, or other suitable electronic processing components. In many embodiments, processor 203A may be a multi-core processor or an array (e.g., one or more) of processors.

The memory 204A (e.g., Random Access Memory (RAM), Read-Only Memory (ROM), Non-volatile RAM (NVRAM), Flash Memory, hard disk storage, optical media) of processing server 202A stores data and/or computer instructions/code for facilitating at least some of the various processes described herein. The memory 204A includes tangible, non-transient volatile memory, or non-volatile memory. The memory 204A stores programming logic (e.g., instructions/code) that, when executed by the processor 203A, controls the operations of the model management system 104. In some embodiments, the processor 203A and the memory 204A form various processing servers described with respect to the model management system 104. The instructions include code from any suitable computer programming language such as, but not limited to, C, C++, C#, Java, JavaScript, VBScript, Perl, HTML, XML, Python, TCL, and Basic. In some embodiments (referred to as “headless servers”), the model management system 104 may omit the input/output processor (e.g., input/output processor 205A), but may communicate with an electronic computing device via a network interface (e.g., network interface 206A).

The model management system 104 includes a network interface 206A configured to establish a communication session with a computing device for sending and receiving data over a network to the computing device. Accordingly, the network interface 206A includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the model management system 104 includes a plurality of network interfaces 206A of different types, allowing for connections to a variety of networks, such as local area networks or wide area networks including the Internet, via different sub-networks.

The model management system 104 includes an input/output server 205A configured to receive user input from and provide information (e.g., OL risk score requests, HP risk score request, recommendation requests, MMS messages, notifications, alerts, etc.) to a user of the model management system 104. In this regard, the input/output processor 205A is structured to exchange data, communications, instructions, etc. with an input/output component of the model management system 104. Accordingly, input/output processor 205A may be any electronic device that conveys data to a user by generating sensory information (e.g., a visualization on a display, one or more sounds, tactile feedback) and/or converts received sensory information from a user into electronic signals (e.g., a keyboard, a mouse, a pointing device, a touch screen display, a microphone). The one or more user interfaces may be internal to the housing of the model management system 104, such as a built-in display, touch screen, microphone, etc., or external to the housing of the model management system 104, such as a monitor connected to the model management system 104, a speaker connected to the model management system 104, etc., according to various embodiments. In some embodiments, the input/output processor 205A includes communication processors, servers, and circuitry for facilitating the exchange of data, values, messages (e.g., OL risk score requests, HP risk score request, recommendation requests, MMS messages, notifications, alerts, etc.), and the like between the input/output device and the components of the model management system 104. In some embodiments, the input/output processor 205A includes machine-readable media for facilitating the exchange of information between the input/output device and the components of the model management system 104. In still another embodiment, the input/output processor 205A includes any combination of hardware components (e.g., a touchscreen), communication processors, servers, circuitry, and machine-readable media.

The model management system 104 includes a device identification processor 207A (shown in FIG. 2A as device ID processor 207A) configured to generate and/or manage a device identifier (e.g., a media access control (MAC) address, an internet protocol (IP) address) associated with the model management system 104. The device identifier may include any type and form of identification used to distinguish the model management system 104 from other computing devices. To preserve privacy, the device identifier may be cryptographically generated, encrypted, or otherwise obfuscated by any server/processor of the model management system 104. The model management system 104 may include the device identifier in any communication (any of the messages in FIG. 1, (e.g., OL risk score requests, HP risk score request, recommendation requests, MMS messages, notifications, alerts, etc.) that the model management system 104 sends to a computing device.

The model management system 104 includes (or executes) an application 270A that the model management system 104 displays on a computer screen (local or remote) allowing a user of the model management system 104 to view and exchange data (e.g., OL risk score requests, HP risk score request, recommendation requests, MMS messages, notifications, alerts, etc.) with any other computing devices (e.g., event data provider 140, market & economic data provider 142, client devices 102, administrator device 103, database system 112) connected to the network 120, or any processor/server and/or subsystem (e.g., OL model 108 and its respective sub-modules 108a-108c, process optimizer model 109, user performance model 110, model management processor 220A) of the model management system 104.

The application 270A includes a collection agent 215A. The collection agent 215A may include an application plug-in, application extension, subroutine, browser toolbar, daemon, or other executable logic for collecting data processed by the application 270A and/or monitoring interactions of a user with the input/output processor 205A. In other embodiments, the collection agent 215A may be a separate application, service, daemon, routine, or other executable logic separate from the application 270A but configured for intercepting and/or collecting data processed by application 270A, such as a screen scraper, packet interceptor, application programming interface (API) hooking process, or other such application. The collection agent 215A is configured for intercepting or receiving data input via the input/output processor 205A, including mouse clicks, scroll wheel movements, gestures such as swipes, pinches, or touches, or any other such interactions; as well as data received and processed by the application 270A. The collection agent 215A, may begin intercepting/gathering/receiving data input via its respective input/output processor based on any triggering event, including, e.g., a power-up of the model management system 104 or a launch of any software application executing on processing server 202A.

The model management system 104 includes an OL model 108, a process optimizer model 109, and a user performance model 110 that each execute (e.g., run) on the processor 203A of the model management system 104. The OL Model 108 executes an OL sub-model 108a, an OL sub-model 108b, and/or an OL sub-model 108c.

The model management system 104 includes a model management processor 220A that may be configured to receive several types of requests. The model management processor 220A may be configured to receive a request (shown in FIG. 1 as “OL risk score request”) for a risk score that is indicative of a probability for an operational loss event to occur responsive to a transaction by the organization 101. The model management processor 220A may be configured to receive a request (shown in FIG. 1 as “HP risk score request”) for a risk score that is associated with user attributes (e.g., physical , mental, emotional, behavioral, etc.) of a user (e.g., a user of a client device 102) of the organization 101. The request (shown in FIG. 1 as “HP risk score request”), in some embodiments, may be a request for a risk score that is indicative of a probability for the user to cause an operational loss event when instructing to execute a transaction. The model management processor 220A may be configured to receive a request (shown in FIG. 1 as “recommendation request”) for improving a procedure (e.g., a workflow, a process, etc.) for transactions made by an organization.

The model management processor 220A may be configured to extract and/or parse information (e.g., user identifier, a description of a predetermined temporal window, etc.) from a request in response to receiving a request. The model management processor 220A may be configured to determine which of the one or more predictive models the model management system 104 could use (or rely on) to respond to the request. The model management processor 220A may be configured to select one or more predictive models (e.g., OL model 108, OL sub-model 108a, OL sub-model 108b, OL sub-model 108c, process optimizer model 109, user performance model 110) from a plurality of predictive models based on the request to generate an output prediction (e.g., risk score, recommendation).

The model management processor 220A may be configured to retrieve one or more sets of data from the database system 112. The model management processor 220A may be configured to generate one or more scoring datasets and/or training datasets based on the data that the model management processor 220A retrieves from the database system 112. The model management processor 220A may be configured to generate a scoring dataset based on a list of candidate transactions that are expected to execute within a predetermined window of time (e.g., 24-hour period). The model management processor 220A may be configured to generate a scoring dataset based on information (e.g., identifier to a client device 102, an identifier to predetermined window of time, etc.) extracted and/or parsed from the request.

The model management processor 220A may be configured to determine whether a predictive model (e.g., OL model 108, OL sub-model 108a, OL sub-model 108b, OL sub-model 108c, process optimizer model 109, user performance model 110) is available to process a request. In some embodiments, a model that has a model accuracy (or some other model evaluation metric) that fails to meet one or more criteria (sometimes referred to as, “model acceptance criteria”) is deemed, “not available.” The model management processor 220A may be configured to, deploy another predictive model into an environment (e.g., environment 100 in FIG. 1) according to the operations of the Training Phase, as discussed herein, if the model management processor 220A determines that a predictive model is not available to process the request. In some embodiments, the newly deployed predictive model has an “acceptable” model accuracy, in that it satisfies one or more model acceptance criteria.

The model management processor 220A may be configured to disable and/or re-train a predictive model responsive to determining that a predictive model fails to meet model accuracy criteria. The model management process 220A may be configured to re-train a predictive model using a different training dataset than the training dataset that the predictive model was trained with prior to deployment into production.

The model management process 220A may be configured to determine (e.g., detect) an occurrence of an event (e.g., an occurrence of a health-related pandemic, the existence of a new client that relies on the model management process 220A, etc.). In response to detecting the event, the model management process 220A may be configured to predict (e.g., determine, forecast, estimate) a likelihood for a predictive model to have an unsatisfactory model accuracy (e.g., failing a model acceptance criteria) as a result of the event. If the likelihood is equal to and/or greater than a predetermined threshold (e.g., 80%, 90%, etc.), then the model management process 220A can re-train the predictive model using a second training dataset that is different from the training dataset that was used to deploy the predictive model into production.

For example, the model management process 220A may train the operational loss model 104 to generate a risk score for a client that is associated with the commodities trading sector. If the model management process 220A discovers (determines) that a new client is also relying on the operational loss model 104 to generate risk scores, and that the new client is associated with an insurance trading sector, then the model management process 220A can re-train the operational loss model 104 using a new training dataset such that the “newly trained” operational loss model 104 can generate accurate risk scores for both clients.

The model management processor 220A may be configured to train any of the predictive models depicted in FIG. 1 (e.g., OL model 108, OL sub-model 108a, OL sub-model 108b, OL sub-model 108c, process optimizer model 109, user performance model 110) according to the operations of the Training Phase, as discussed herein.

The model management processor 220A may be configured to apply (e.g., insert) one or more scoring datasets to a predictive model that is trained with a training dataset to cause the predictive model to generate an output prediction. The model management processor 220A may be configured to apply a scoring dataset to the OL model 108a that is trained with a training dataset (e.g., market data and economic data), to cause the OL model 108a to generate a risk score that is indicative of a probability for an operational loss event to occur responsive to a transaction by the organization 101. The model management processor 220A may be configured to apply a scoring dataset to the OL model 108b that is trained with a training dataset (e.g., market data), to cause the OL model 108b to generate a risk score that is indicative of a probability for an operational loss event to occur responsive to a transaction by the organization 101. The model management processor 220A may be configured to apply a scoring dataset to the OL model 108c that is trained with a training dataset (e.g., market data and security data associated with the organization 101), to cause the OL model 108c to generate a risk score that is indicative of a probability for an operational loss event to occur responsive to a transaction by the organization 101.

The model management processor 220A may be configured to apply a scoring dataset to the user performance model 110 that is trained with a training dataset (e.g., one or more of: historical personal attributes of one or more user, historical market data, historical economic data, historical security data), to cause the user performance model 110 to generate a risk score that is indicative of a probability for the user to cause an operational loss event when instructing to execute a transaction.

The model management processor 220A may be configured to apply a scoring dataset to the process optimizer model 109 that is trained with a training dataset (e.g., one or more of historical personal attributes of one or more users, historical market data, historical economic data, or historical security data), to cause the process optimizer model 109 to generate to one or more recommendations for mitigating (or nullifying) the risk of an operational loss event occurring as a result of a transaction. In some embodiments, the one or more recommendations are formatted in a list.

The model management processor 220A may be configured to receive one or more risk scores and/or recommendations from the one or more predictive models. The model management processor 220A may be configured to determine that a score (e.g., a risk score) satisfies one or more criteria (sometimes referred to as, “model acceptance criteria”). The model management processor 220A may be configured to determine that the score satisfies one or more criteria by comparing the score to the one or more criteria.

The model management processor 220A may be configured to send a message (sometimes referred to as an, “MMS message”) to an administrator device 103, where the messages causes the administrator device 103 to present one or more risk scores and/or recommendations on a display (e.g., computer display 105) that is associated with the administrator device 103. In some embodiments, the message may cause the administrator device 103 to send a second message (sometimes referred to as a “notification message”) to one or more client devices 102 to cause the one or more client devices 102 to present the risk score and/or the recommendations on a display of the one or more client devices 102.

The model management system 104 includes a bus (not shown), such as an address/data bus or other communication mechanism for communicating information, which interconnects processors, servers, and/or subsystems of the model management system 104. In some embodiments, the model management system 104 may include one or more of any such processors, servers, and/or subsystems.

In some embodiments, some or all of the processors/servers of the model management system 104 may be implemented with the processing server 202A. For example, any of the model management system 104 may be implemented as a software application stored within the memory 204A and executed by the processor 203A. Accordingly, such arrangement can be implemented with minimal or no additional hardware costs. Any of these above-recited servers/processors may rely on dedicated hardware specifically configured for performing operations of the server/processor.

FIG. 2B is a block diagram depicting an example client device of the environment in FIG. 1, according to some embodiments. While various processors, servers, interfaces, and logic with particular functionality are shown, it should be understood that the client device 102 includes any number of servers, interfaces, and logic for facilitating the functions described herein. For example, the activities of multiple servers may be combined as a single server and implemented on a single processing server (e.g., processing server 202B), as additional servers with additional functionality are included.

The client device 102 includes a processing server 202B composed of one or more processors 203B and a memory 204B. The processing server 202B includes identical or nearly identical functionality as processing server 202A in FIG. 2A, but with respect to servers and/or subsystems of the client device 102 instead of servers and/or subsystems of the model management system 104.

The memory 204B of processing server 202B stores data and/or computer instructions/code for facilitating at least some of the various processes described herein. The memory 204B includes identical or nearly identical functionality as memory 204A in FIG. 2A, but with respect to servers and/or subsystems of the client device 102 instead of servers and/or subsystems of the model management system 104.

The client device 102 includes a network interface 206B configured to establish a communication session with a computing device for sending and receiving data over a network to the computing device. Accordingly, the network interface 206B includes identical or nearly identical functionality as network interface 206A in FIG. 2A, but with respect to servers and/or subsystems of the client device 102 instead of servers and/or subsystems of the model management system 104.

The client device 102 includes an input/output server 205B configured to receive user input from and provide information to a user. In this regard, the input/output server 205B is structured to exchange data, communications, instructions, etc. with an input/output component of the client device 102. The input/output server 205B includes identical or nearly identical functionality as input/output processor 205A in FIG. 2A, but with respect to servers and/or subsystems of the client device 102 instead of servers and/or subsystems of the model management system 104.

The client device 102 includes a device identification server 207B (shown in FIG. 2B as device ID server 207B) configured to generate and/or manage a device identifier associated with the client device 102. The device ID server 207B includes identical or nearly identical functionality as device ID processor 207A in FIG. 2A, but with respect to servers and/or subsystems of the client device 102 instead of servers and/or subsystems of the model management system 104.

The client device 102 includes (or executes) an application 270B that the client device 102 displays on a computer screen allowing a user of the client device 102 to view and exchange data (e.g., transactions, trades, user data, notifications, alerts) with any other computing devices (e.g., administrator device 103, model management system 104) connected to the network 120, or any server and/or subsystem of the client device 102. The application 270B includes a collection agent 215B. The application 270B and the collection agent 215B include identical or nearly identical functionality as their respective counter-part (e.g., application 270A in FIG. 2A and collection agent 215A in FIG. 1A), but with respect to servers and/or subsystems of the client device 102 instead of servers and/or subsystems of the model management system 104.

The client device 102 includes a transaction server 220B that may be configured to generate and send transaction (e.g., capital market trades) via a secondary or primary market, neither of which are shown in FIG. 1.

The client device 102 may be configured to receive a message from the administrator device 103. In response to receiving the message, the client device 102 extracts one or more risk scores and/or recommendations and presents the one or more risk scores and/or recommendations on a display associated with the one or more client devices 102.

The client device 102 includes a bus (not shown), such as an address/data bus or other communication mechanism for communicating information, which interconnects servers and/or subsystems of the client device 102. In some embodiments, the client device 102 may include one or more of any such servers and/or subsystems.

In some embodiments, some or all of the servers of the client device 102 may be implemented with the processing server 202B. For example, any of the client device 102 may be implemented as a software application stored within the memory 204B and executed by the processor 203B. Accordingly, such arrangement can be implemented with minimal or no additional hardware costs. Any of these above-recited servers may rely on dedicated hardware specifically configured for performing operations of the server.

FIG. 2C is a block diagram depicting an example administrator device of the environment in FIG. 1, according to some embodiments. While various processors, servers, interfaces, and logic with particular functionality are shown, it should be understood that the administrator device 103 includes any number of servers, interfaces, and logic for facilitating the functions described herein. For example, the activities of multiple servers may be combined as a single server and implemented on a single processing server (e.g., processing server 202C), as additional servers with additional functionality are included.

The administrator device 103 includes a processing server 202C composed of one or more processors 203C and a memory 204C. The processing server 202C includes identical or nearly identical functionality as processing server 202A in FIG. 2A, but with respect to servers and/or subsystems of the administrator device 103 instead of servers and/or subsystems of the model management system 104.

The memory 204C of processing server 202C stores data and/or computer instructions/code for facilitating at least some of the various processes described herein. The memory 204C includes identical or nearly identical functionality as memory 204A in FIG. 2A, but with respect to servers and/or subsystems of the administrator device 103 instead of servers and/or subsystems of the model management system 104.

The administrator device 103 includes a network interface 206C configured to establish a communication session with a computing device for sending and receiving data over a network to the computing device. Accordingly, the network interface 206C includes identical or nearly identical functionality as network interface 206A in FIG. 2A, but with respect to servers and/or subsystems of the administrator device 103 instead of servers and/or subsystems of the model management system 104.

The administrator device 103 includes an input/output server 205C configured to receive user input from and provide information to a user. In this regard, the input/output server 205C is structured to exchange data, communications, instructions, etc. with an input/output component of the administrator device 103. The input/output server 205C includes identical or nearly identical functionality as input/output processor 205A in FIG. 2A, but with respect to servers and/or subsystems of the administrator device 103 instead of servers and/or subsystems of the model management system 104.

The administrator device 103 includes a device identification server 207C (shown in FIG. 2C as device ID server 207C) configured to generate and/or manage a device identifier associated with the administrator device 103. The device ID server 207C includes identical or nearly identical functionality as device ID processor 207A in FIG. 2A, but with respect to servers and/or subsystems of the administrator device 103 instead of servers and/or subsystems of the model management system 104.

The administrator device 103 includes (or executes) an application 270C that the administrator device 103 displays on a computer screen allowing a user of the administrator device 103 to view and exchange data (e.g., OL risk score requests, HP risk score requests, recommendation requests, MMS messages and their respective contents, risk scores, recommendations, notifications, alerts, etc.) with any other computing devices (e.g., client devices 102, model management system 104) connected to the network 120, or any server and/or subsystem of the administrator device 103. The application 270C includes a collection agent 215C. The application 270C and the collection agent 215C include identical or nearly identical functionality as their respective counter-part (e.g., application 270A in FIG. 2A and collection agent 215A in FIG. 1A), but with respect to servers and/or subsystems of the administrator device 103 instead of servers and/or subsystems of the model management system 104.

The administrator device 103 includes an administrator server 220C that may be configured to generate and send a request (e.g., OL risk score request, HP risk score request, recommendation request) to a model management system 104 for one or more risk scores and/or recommendations.

The administrator device 103 may be configured to receive a message (sometimes referred to as an, “MMS message”) from the model management system 104. The administrator device 103 may be configured to extract one or more risk scores and/or recommendations from the message and present the extracted scores and/or recommendations on a display (e.g., computer display 105) associated with the administrator device 103. The administrator device 103 may be configured to send (e.g., forward, redirect) the message to one or more client devices 102, causing the one or more client devices 102 to present one or more risk scores and/or recommendations on a display associated with the one or more client devices 102.

The administrator 103 includes a bus (not shown), such as an address/data bus or other communication mechanism for communicating information, which interconnects servers and/or subsystems of the administrator device 103. In some embodiments, the administrator device 103 may include one or more of any such servers and/or subsystems.

In some embodiments, some or all of the servers of the administrator device 103 may be implemented with the processing server 202C. For example, any of the administrator device 103 may be implemented as a software application stored within the memory 204C and executed by the processor 203C. Accordingly, such arrangement can be implemented with minimal or no additional hardware costs. Any of these above-recited servers may rely on dedicated hardware specifically configured for performing operations of the server.

### 3. Training a Model and Calculating Model Accuracy

As discussed herein, each training dataset consists of a plurality of input features (sometimes referred to as “input variables”). Similarly, each scoring dataset also consists of a plurality of input features. For a predictive model (e.g., OL model 108a-c, process optimizer model 109, and user performance model 110 in FIG. 1) to produce an accurate prediction, the scoring dataset that the model uses to generate an output prediction (e.g., OL risk score, optimization recommendations, HP risk score) should include at least one of the same input features from the training data.

3.1 Training a Predictive Model with Two-Class Boosted Decision Tree Regression

The model management system 104 may be configured, in some embodiments, to train one or more of the predictive models (e.g., OL model 108a-c, process optimizer model 109, and user performance model 110 in FIG. 1) using a Two-Class Boosted Decision Tree Regression algorithm. The model management system 104 uses the algorithm to make “boosted decision,” where boosting means that each tree is dependent on prior trees. The model management system 104 uses the algorithm, which learns (e.g., acquires, determines) by fitting the residual of the trees that preceded it. Thus, boosting in a decision tree ensemble tends to improve accuracy with some small risk of less coverage. This regression method is a supervised learning method, and therefore, in some embodiments, requires a labeled dataset. The label column, in some embodiments, must contain numerical values.

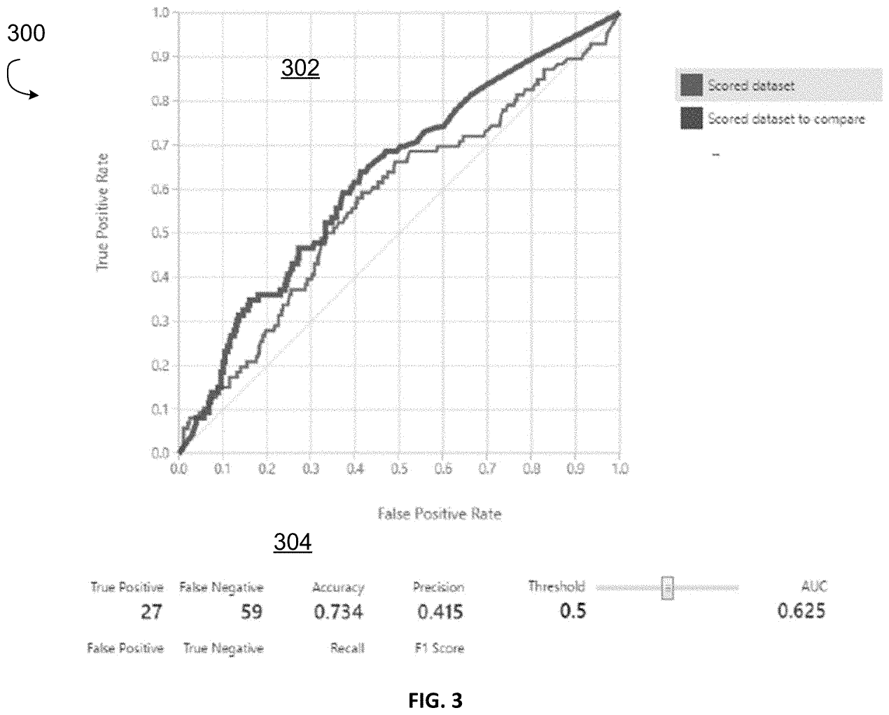

FIG. 3 is a graphical user interface of an example application depicting a method for displaying model evaluation results for a predictive model, according to some embodiments. The application may be application 270A in FIG. 2A that executes on the model management system 104 in FIG. 1. The application may be application 270C in FIG. 2C that executes on the administrator device 103.

The GUI 300 may include chart 302 that indicates true positive (TP) rates and false positive (FP) rates for a model (e.g., OL model 108a-c, process optimizer model 109, and user performance model 110 in FIG. 1). The TPs correspond to the correctly predicted positive values which means that the value of actual class is ‘yes’ and the value of predicted class is also ‘yes.’ The FPs correspond to when actual class is ‘no’ and predicted class is ‘yes.’

The GUI 300 may include table 304 depicting the model evaluation results for a predictive model. The table 304 includes TPs. The table 304 includes false negatives (FN), which indicates when actual class is ‘yes’ but predicted class in ‘no.’ The table 304 includes Accuracy, which is a performance measure based on, in some embodiments, a ratio of correctly predicted observation to the total observations. The higher the model accuracy number, then the more likely that the predictive model (e.g., OL model 108a-c, process optimizer model 109, and user performance model 110 in FIG. 1) will make the correct prediction. In some embodiments, the model management system 104 in FIG. 1 may calculate the accuracy for a predictive model based on the following algorithm:

$$Accuracy = \frac{( TP + TN )}{( TP + FP + FN + TN )} \qquad ( 1 )$$

The table 306 includes Precision is the ratio of correctly predicted positive observations to the total predicted positive observations. In some embodiments, the model management system 104 in FIG. 1 may calculate the precision for a predictive model based on the following algorithm:

$$Precision = \frac{( TP )}{( TP + FP )} \qquad ( 2 )$$

The table 304 may show any other statistics depicting the evaluation results for a predictive mode. For example, the table 304 may include true negatives (TN) indicating the correctly predicted negative values which means that the value of actual class is ‘no’ and value of predicted class is also ‘no.’

The table 304 may include Recall (Sensitivity), which is the ratio of correctly predicted positive observations to the all observations in actual class—‘yes.’ In some embodiments, the model management system 104 in FIG. 1 may calculate the Recall for a predictive model based on the following algorithm:

$$Recall = \frac{( TP )}{( TP + FN )} \qquad ( 3 )$$

The table 304 may include F 1 score, which is the weighted average of Precision and Recall. Therefore, this score takes both false positives and false negatives into account. Intuitively it is not as easy to understand as accuracy, but F1 is usually more useful than accuracy, especially if you have an uneven class distribution. Accuracy works best if false positives and false negatives have similar cost. If the cost of false positives and false negatives are very different, in some embodiments, it may be better to look at both Precision and Recall.

Boosting is method for creating ensemble models. In some embodiments, an ensemble model may be created by using the bagging method and/or the random forests method. In some embodiments, boosted decision trees use an efficient implementation of the Multiple Additive Regression Trees (MART) gradient boosting algorithm. Gradient boosting is a machine learning technique for regression problems. It builds each regression tree in a step-wise fashion, using a predefined loss function to measure the error in each step and correct for it in the next. Thus, the prediction model is an ensemble of weaker prediction models. In regression problems, boosting builds a series of trees in a step-wise fashion, and then selects the optimal tree using an arbitrary differentiable loss function.

### 3.2. Calculating Model Accuracy

When a predictive model is deployed into production, however, the accuracy of the predictive model can change over time. One cause for this change may be as a result of data drift (also referred to as, “variable drift,” “model drift,” or “concept drift”), which is when the relationship between the input features and the output predictions made by a predictive model change over time. Hence, as a result of data drift, the accuracy of the predictive model may decrease over time.

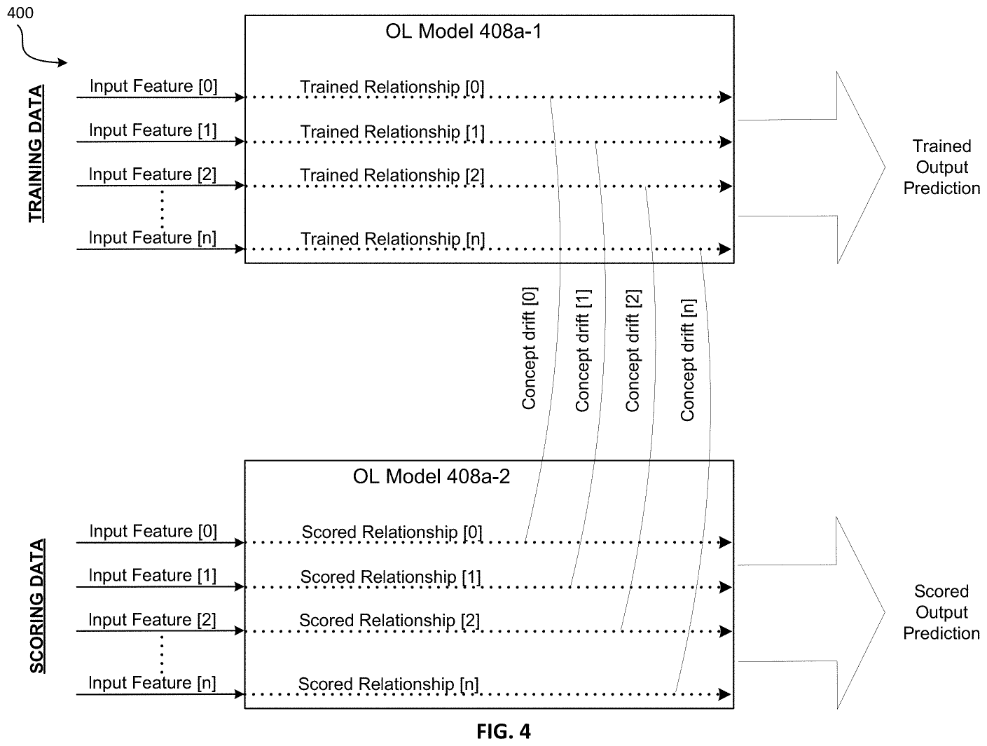

FIG. 4 is a block diagram depicting trained relationships, scored relationships, and concept drifts in relation to input features for an example predictive model of the environment in FIG. 1, according to some arrangements. The block diagram 400 includes a predictive model 402a-1 and a predictive model 402a-2, where both predictive models 402a-1, 402a-1 refer to the same predictive model (e.g., OL Model 108a in FIG. 1), but under different conditions.

In particular, the predictive model 408a-1 illustrates the plurality of trained relationships that are generated after a computing device (e.g., model management system 104 in FIG. 1) trains the predictive model. Training a predictive model causes the predictive model to maintain a plurality of trained relationships, where each of trained relationships are associated with a respective input feature of the training dataset and a trained output prediction (e.g., OL risk score in FIG. 1, HP risk score in FIG. 1, optimization recommendations in FIG. 1) generated by the predictive model based on the training dataset. For example, a training dataset may consist of a first input feature (e.g., input feature [0] in FIG. 4), a second input feature (e.g., input feature [1] in FIG. 4), a third input feature (e.g., input feature [2] in FIG. 4), up to an n-th input feature (e.g., input feature [n] in FIG. 4). Accordingly, training a predictive model with the training dataset would cause the predictive model to maintain a first relationship (e.g., trained relationship [0] in FIG. 4) between the first input feature and the output prediction generated based on all (e.g., input feature [0], input feature [1], input feature [2], up to input feature [n]) of the input features of the training data; a second relationship (e.g., trained relationship [1] in FIG. 4) between the second input feature and the output prediction generated based on all of the input features of the training dataset; a third relationship (e.g., trained relationship [2] in FIG. 4) between the third input feature and the output prediction generated based on all of the input features of the training data; and an n-th relationship (e.g., trained relationship [n] in FIG. 4) between the n-th input feature and the output prediction generated based on all of the input features of the training dataset.

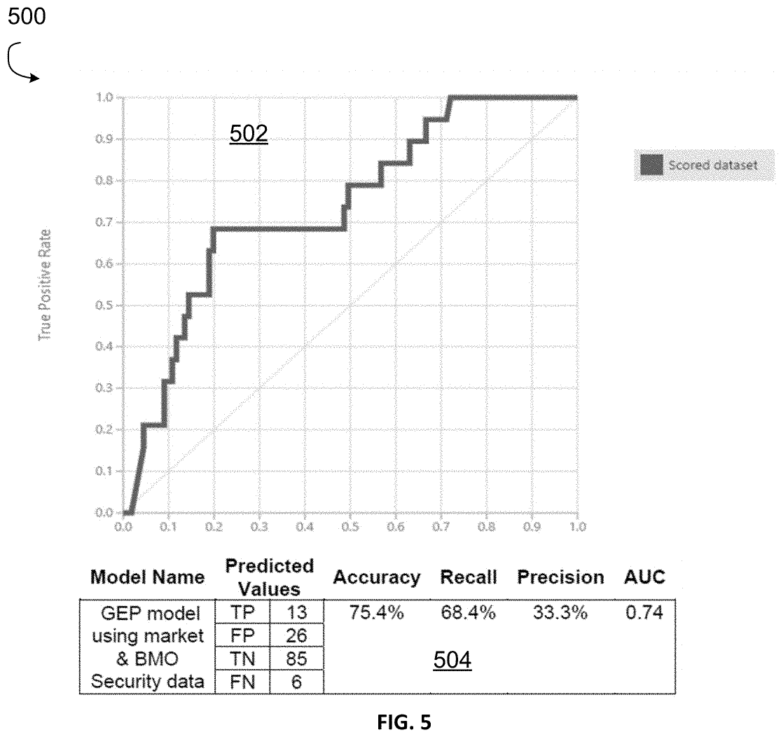

The predictive model 408a-2 illustrates the plurality of scored relationships that are generated after a trained predictive model (e.g., predictive model 408a-1) consumes a scoring dataset consisting of a plurality of input features. For example, a scoring dataset may consist of a first input feature (e.g., input feature [0] in FIG. 4), a second input feature (e.g., input feature [1] in FIG. 4), a third input feature (e.g., input feature [2] in FIG. 5), up to an n-th input feature (e.g., input feature [n] in FIG. 4). Specifically, input feature [0] of the scoring dataset is the same input feature [0] of the training data, input feature [1] of the scoring dataset is the same input feature [1] of the training dataset, input feature [2] of the scoring dataset is the same input feature [2] of the training dataset, and input feature [n] of the scoring dataset is the same input feature [n] of the training dataset.

Upon consuming the scoring dataset, the predictive model would maintain (or exhibit) a first relationship (e.g., scored relationship [0] in FIG. 4) between the first input feature and the output prediction generated based on all (e.g., input feature [0], input feature [1], input feature [2], up to input feature [n]) of the input features of the scoring dataset; a second relationship (e.g., scored relationship [1] in FIG. 4) between the second input feature and the output prediction generated based on all of the input features of the scoring dataset; a third relationship (e.g., scored relationship [2] in FIG. 4) between the third input feature and the output prediction generated based on all of the input features of the scoring dataset; and an n-th relationship (e.g., scored relationship [n] in FIG. 4) between the n-th input feature and the output prediction generated based on all of the input features of the scoring dataset.

The block diagram 400 illustrates a plurality of concept drifts, where each concept drift is calculated based on a difference between a trained relationship associated with an input feature and a scored relationship associated with the same input feature. For example, concept drift [0] is the concept drift calculated based on the trained relationship [0] and the scored relationship [0], concept drift [1] is the concept drift calculated based on the trained relationship [1] and the scored relationship [1], concept drift [2] is the concept drift calculated based on the trained relationship [2] and the scored relationship [2], and concept drift [n] is the concept drift calculated based on the trained relationship [n] and the scored relationship [n].

### 3.3 Model Acceptance Criteria

The model management system 104 in FIG. 1 may be configured to periodically calculate the effects of model drift (e.g., concept drift) on model accuracy to access whether a model satisfies one or more model acceptance criteria for production. In some embodiments, the model management system 104 calculates the effects of model drift on model accuracy in responsive to detecting that an event occurred that the model management system 104 determines could have an impact on model accuracy.

Possible types of event data (as discussed herein) that may trigger the model management system 104 to calculate model accuracy and/or re-train a model may include, for example, health data and/or health-related pandemic data (e.g., COVID-19, flu, etc.), local news, national news, foreign news, calendar events (e.g., holidays), weather data, publications, customer data, data indicating that a new customer is relying on model management system 104 in FIG. 1, casualty and/or disaster information, etc.

To calculate model accuracy, in some embodiments, the model management system 104 determines whether a predictive model (e.g., OL model 108a-c, process optimizer model 109, and user performance model 110 in FIG. 1) satisfies one or more criteria (or all) by comparing one or more evaluation metrics (e.g., accuracy, precision, recall, concept drift value, etc.) of the predictive model against one or more predetermined thresholds and/or one or more criteria.

A “first” criteria, in some embodiments, could indicate that a predictive model that has a model accuracy that is equal to and/or lower than a predetermined threshold (e.g., 60%) would fail to satisfy the criteria, while a predictive model having a model accuracy that is equal to and/or higher than the predetermined threshold (e.g., 60%) would successfully satisfy the criteria.

A “second” criteria, in some embodiments, could relate to an Area Under a Curve (AUC). For example, FIG. 5 is a graphical user interface of an example application depicting an AUC for calculating model accuracy for a predictive model, according to some embodiments. The application may be application 270A in FIG. 2A that executes on the model management system 104 in FIG. 1. The application may be application 270C in FIG. 2C that executes on the administrator device 103.

The GUI 500 may include chart 502 and table 504 that indicates TP rates and FP rates for a model (e.g., OL model 108a-c, process optimizer model 109, and user performance model 110 in FIG. 1). The TPs correspond to the correctly predicted positive values which means that the value of actual class is ‘yes’ and the value of predicted class is also ‘yes.’ The FPs correspond to when actual class is ‘no’ and predicted class is ‘yes.’

The “second criteria” could indicate that a predictive model that has an AUC that is equal to and/or lower than a predetermined threshold (e.g., 0.6) would fail to satisfy the criteria, while a predictive model having an AUC that is equal to and/or higher than the predetermined threshold (e.g., 0.6) would successfully satisfy the criteria.

A “third” criteria, in some embodiments, could indicate that a predictive model that has a Recall and/or Precision calculation that is equal to and/or lower than a predetermined threshold (e.g., 30%) would fail to satisfy the criteria, while a predictive model having a Recall and/or Precision calculation that is equal to and/or higher than the predetermined threshold (e.g., 30%) would successfully satisfy the criteria.

### 4. Graphical User Interface for Implementing the Illustrative Embodiment(s)

FIGS. 7-10 various graphical user interfaces provided by one or more servers of one or more systems described herein, such as model management system 104 described in FIG. 1 are depicted. Using various graphical components provided within the GUIs described herein, an end-user (e.g., an administrator) may select various attributes used by one or more servers described herein to generate (e.g., train and/or re-train) and execute the predictive models (e.g., OL model 108 and its respective sub-modules 108a-108c, process optimizer model 109, user performance model 110 in FIG. 1), such that the results are applicable to the end-user's particular needs. For instance, using the graphical components described herein an end-user may tailor the results of the predictive models by instructing one or more servers to analyze a set of data based on a particular group, a particular user, and/or a particular window of time. In this example, the user experience may start by an end-user interacting with the GUI depicted in FIG. 7.

FIG. 7 is a graphical user interface of an example application depicting a method for displaying a plurality of risk scores produced by predictive models, according to some embodiments. The application may be application 270A in FIG. 2A that executes on the model management system 104. The application may be application 270C in FIG. 2C that executes on the administrator device 103.

The GUI 700 may include a region 720 that displays a date range component 703 and operating group buttons 704. The GUI 700 may include a region 710 for displaying one or more capital market product groups. The GUI 700 may include region 720 for displaying the output (e.g., one or more risk scores) of the OL sub-model 108a in FIG. 1. The region 720 shows a list of capital market indexes 722, a corresponding risk score 724 for each index, and a total risk score 726 representative of all of the risk scores 724. The region 720 includes a scroll bar 725 that an end-user may interact with to scroll in an upward direction or downward direction in order to view all (not shown in region 720) the capital market indexes 722 and corresponding risk scores 724 for each index.

The GUI 700 may include region 730 for displaying the output (e.g., one or more risk scores) of the OL sub-model 108b in FIG. 1. The region 730 shows a list of capital market indexes 732, a corresponding risk score 734 for each index, and a total risk score 736 representative of all of the risk scores 734. The region 730 includes a scroll bar 735 that an end-user may interact with to scroll in an upward direction or downward direction in order to view all (not shown in region 730) the capital market indexes 732 and corresponding risk scores 734 for each index.

The GUI 700 may include region 740 for displaying the output (e.g., one or more risk scores) of the OL sub-model 108c in FIG. 1. The region 740 shows a list of capital market indexes 742, a corresponding risk score 744 for each index, and a total risk score 746 representative of all of the risk scores 744. The region 740 includes a scroll bar 745 that an end-user may interact with to scroll in an upward direction or downward direction in order to view all (not shown in region 740) the capital market indexes 742 and corresponding risk scores 744 for each index.

The end-user may select a date range for producing predictive model results (e.g., risk scores) by interacting with the data range component 703. The end-user may select one or more operating groups by interacting with the operating group buttons 704. In response to interacting with the date range component 703 and/or the operating group buttons 704, the computing device (e.g., administrator device 103 in FIG. 1) executing the GUI 700 sends a request for risk scores to the one or more processors (e.g., one or more processors of the model management system 104 in FIG. 1), as discussed with respect to operation 602 in FIG. 6A. In some embodiments, the one or more processors creates and/or trains a predictive model to serve the request responsive to the user interacting with the date range component 703 and/or the operating group buttons 704. The one or more processors generate and apply the scoring dataset to one or more predictive models, as discussed with respect to operation 604 in FIG. 6A.

The one or more processors retrieve (e.g., receive, acquire, gather, etc.) the risk scores produced by the one or more predictive models and send (e.g., transmit, deliver, provide, etc.) the risk scores to the computing device executing the GUI 700, as discussed with respect to operation 606 in FIG. 6A. The GUI 700 displays the risk scores in region 720, region 730, and region 740 according to the capital market product group that a user selects in region 710. For example, GUI 700 shows that a user selected a capital market product group 712 corresponding to “Canadian Facilitation Trading,” which caused the GUI 700 to present the risk scores for capital market indexes (e.g., capital market indexes 722, 732, 742) that are associated with the capital market product group 712. The region 710 includes a total risk score for each capital market group that is listed in region 710, where each total risk score represents the total risk score for all the capital market indexes associated with the capital market group.

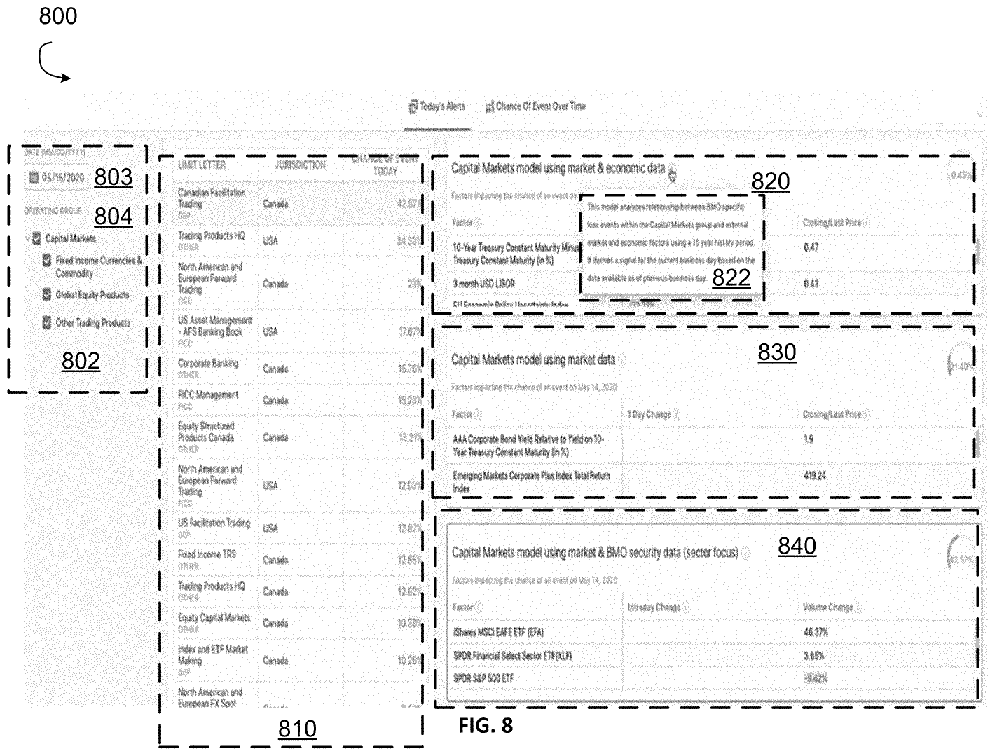

FIG. 8 is a graphical user interface of an example application depicting a method for displaying a plurality of risk scores produced by predictive models, according to some embodiments. The application may be application 270A in FIG. 2A that executes on the model management system 104. The application may be application 270C in FIG. 2C that executes on the administrator device 103.

The GUI 800 may include a region 802 that displays a data range component 803 and operating group buttons 804. The GUI 800 may include a region 810 for displaying one or more capital market product groups. The GUI 800 may include region 820 for displaying the output (e.g., one or more risk scores) of the OL sub-model 108a in FIG. 1. The GUI 800 may include region 830 for displaying the output (e.g., one or more risk scores) of the OL sub-model 108b in FIG. 1. The GUI 800 may include region 840 for displaying the output (e.g., one or more risk scores) of the OL sub-model 108c in FIG. 1.

The end-user may hover (e.g., float) over or interact with a portion of region 820, which causes GUI 800 to display a pop-up screen 822 with a message about the region 820.

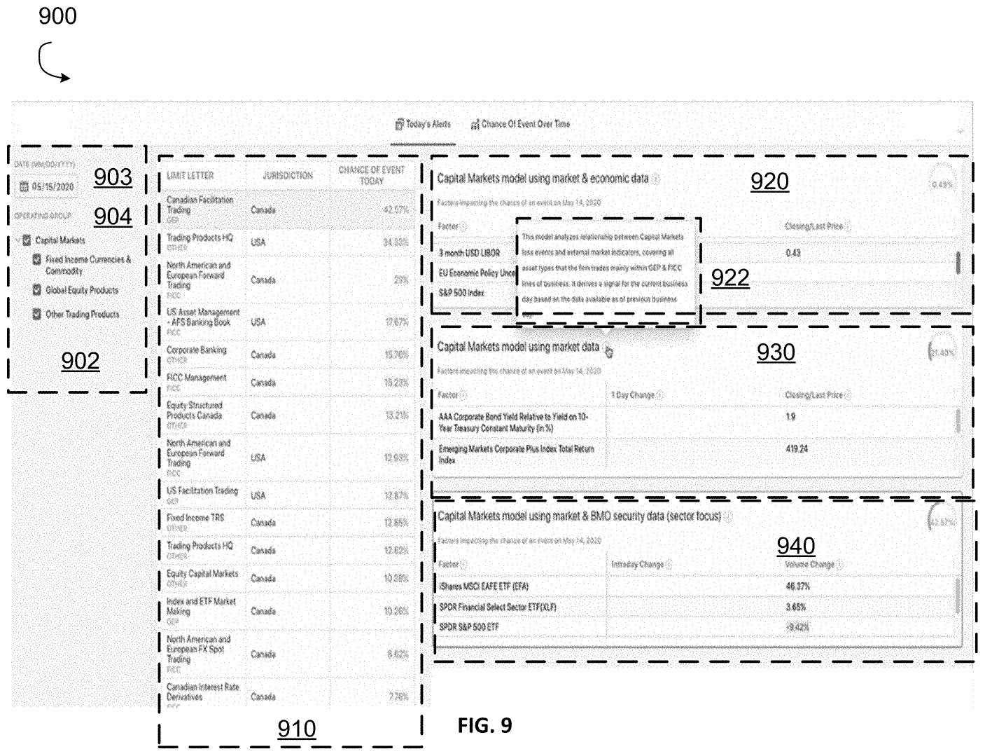

FIG. 9 is a graphical user interface of an example application depicting a method for displaying a plurality of risk scores produced by predictive models, according to some embodiments. The application may be application 270A in FIG. 2A that executes on the model management system 104. The application may be application 270C in FIG. 2C that executes on the administrator device 103.

The GUI 900 may include a region 902 that displays a data range component 903 and operating group buttons 904. The GUI 900 may include a region 910 for displaying one or more capital market product groups. The GUI 900 may include region 920 for displaying the output (e.g., one or more risk scores) of the OL sub-model 108a in FIG. 1. The GUI 900 may include region 930 for displaying the output (e.g., one or more risk scores) of the OL sub-model 108b in FIG. 1. The GUI 900 may include region 940 for displaying the output (e.g., one or more risk scores) of the OL sub-model 108c in FIG. 1.

The end-user may hover (e.g., float) over or interact with a portion of region 930, which causes GUI 900 to display a pop-up screen 922 with a message about the region 930.

The GUI 1000 may include chart 1002 that indicates a chance of an operational loss event occurring at various moments in time, according to some embodiments. For instance, a predictive model predicted that there is a 9% chance of an operational loss event occurring at time ‘1,’ a 3% chance of an operational loss event occurring at time ‘2,’ a 5% chance of an operational loss event occurring at a time ‘3,’ a 1% chance of an operational loss event occurring at time ‘4,’ a 31.07% chance of an operational loss event occurring at time ‘4,’ and a 50% chance of an operational loss event occurring at time ‘5.’

The end-user may generate (and operate) other predictive models (e.g., process optimizer model 109, user performance model 110 in FIG. 1) and display their respective outputs using similar methods as described above (e.g., inputting various features and attributes using GUIs depicted in FIGS. 4-10).

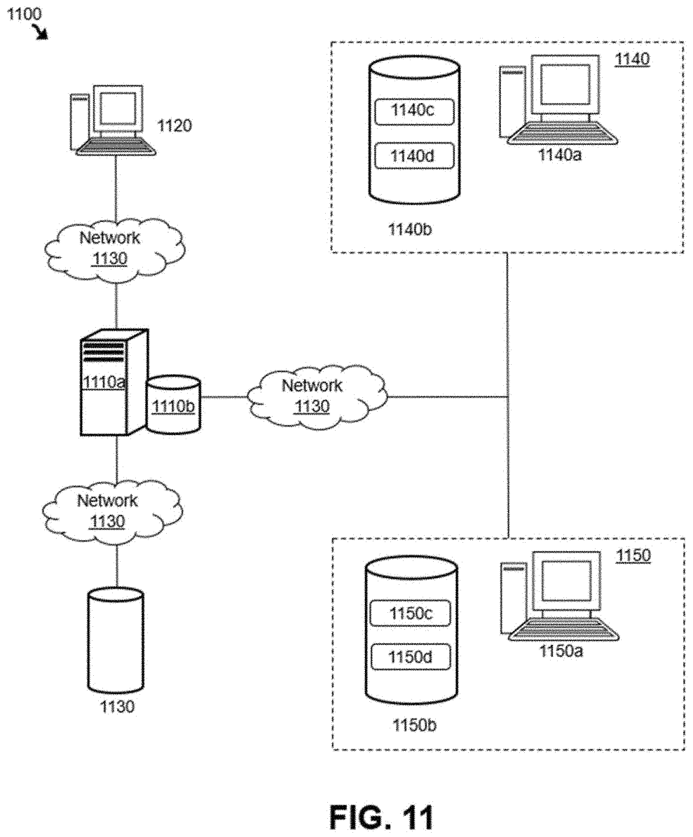

FIG. 11 shows an environment for predicting operational loss events in transactions using artificial intelligence modeling, according to an embodiment. A central server (referred to herein as the analytics server 1110a) can retrieve and analyze data using various methods described herein to execute one or more of the AI models to identify a likelihood of loss. The analytics server may represent one or more processors/servers described herein. For instance, the analytics server 1110a may be a processor of the model management system described in FIGS. 1 and 2A. FIG. 11 depicts is a non-limiting example of components of a system in which the analytics server 1110a operates. For instance, the analytics server 1110a may utilize the model management system described herein to provide services for different end users. The AI models described herein can be utilized and specifically trained for different clients, such that the trained models can be used to predict various scores (e.g., likelihood of loss) for different clients based on each client's specific and proprietary data. The analytics server 1110a may utilize features described in FIG. 11 (system 1100) to retrieve data and generate client-specific results without comingling each client's proprietary data.

System 1100 includes an analytics server 1110a, system database 1110b, an administrator computing device 1120, database 1130, client device 1140a and database 1140b (collectively referred to herein as client 1140), and client device 1150a and database 1150b (collectively referred to herein as client 1150). The above-mentioned components may be connected to each other through a network 1130. The examples of the network 1130 may include, but are not limited to, private or public LAN, WLAN, MAN, WAN, and the Internet. The network 1130 may include both wired and wireless communications according to one or more standards and/or via one or more transport mediums.

The communication over the network 1130 may be performed in accordance with various communication protocols such as Transmission Control Protocol and Internet Protocol (TCP/IP), User Datagram Protocol (UDP), and IEEE communication protocols. In one example, the network 1130 may include wireless communications according to Bluetooth specification sets or another standard or proprietary wireless communication protocol. In another example, the network 1130 may also include communications over a cellular network, including, e.g., a GSM (Global System for Mobile Communications), CDMA (Code Division Multiple Access), EDGE (Enhanced Data for Global Evolution) network.

The system 1100 is not confined to the components described herein and may include additional or other components, not shown for brevity, which are to be considered within the scope of the embodiments described herein. For instance, various AI models described herein are not shown. Moreover, the system 1100 only depicts two client systems (1140, 1150), but more client systems may be included. In FIG. 11, the system 1100 depicts a system architecture that allows the AI models described herein to be executed for different clients without co-mingling of data from each client system.

The analytics server 1110a may generate and display an electronic platform configured to use various computer models (including the AI models described herein) to calculate and display likelihood of operational loss events (as depicted in FIGS. 7-10) for different client systems (e.g., client systems 1140, 1150). For instance, a first user may operate the client device 1140a to access the platform hosted and/or generated by the analytics server 1110a to view a GUI that corresponds to signals (e.g., scores) outputted by one or more AI models descried herein. Similarly, a second user may operate the client device 1150a to access the same platform to view results specific to client 1150.

An example of the electronic platform generated and hosted by the analytics server 1110a may be a web-based application or a website configured to be displayed on different electronic devices, such as mobile devices, tablets, personal computer, and the like. In a non-limiting example, a client may access the platform and instruct the analytics server 1110a to generate one or more signals/scores using various AI models described herein. As a result, the analytics server 1110a may utilize the methods and systems described herein to execute one or more AI models accordingly (using that particular client's data) and display the results on the platform.

The analytics server 1110a may generate and/or host a website accessible to users operating any of the electronic devices described herein (e.g., end-users or clients), where the content presented via the various webpages may be controlled based upon each particular user's role or viewing permissions. For instance, the analytics server 1110a may not display proprietary data associated with the client 1150 on the platform displayed on the client device 1140a.

The analytics server 1110a may be any computing device comprising a processor and non-transitory machine-readable storage capable of executing the various tasks and processes described herein. Non-limiting examples of such computing devices may include workstation computers, laptop computers, server computers, and the like. While the system 1100 includes a single analytics server 1110a, the analytics server 1110a may include any number of computing devices operating in a distributed computing environment. The analytics server 1110a may execute software applications configured to display the electronic platform (e.g., host a website), which may generate and serve various webpages to each client 1140 and/or 1150.

The analytics server 1110a may be configured to require user authentication based upon a set of user authorization credentials (e.g., username, password, biometrics, cryptographic certificate, and the like). In such implementations, the analytics server 1110a may access the system database 1110b configured to store user credentials, which the analytics server 1110a may be configured to reference in order to determine whether a set of entered credentials (purportedly authenticating the user) match an appropriate set of credentials that identify and authenticate the user.

The analytics server 1110a may also store data associated with each user operating one or more electronic data devices associated with each client (e.g., client device 1140a and/or 1150a) separately. The analytics server 1110a may use the data to weigh interactions while training various AI models. For instance, the analytics server 1110a may monitor the user's interactions with the GUIs described herein and may use the collected data to train the AI models accordingly.

In some configurations, the analytics server 1110a may generate and host webpages based upon a particular user's role within the system 1100. In such implementations, the user's role may be defined by data fields and input fields in user records stored in the system database 1110b. The analytics server 1110a may authenticate the user and may identify the user's role by executing an access directory protocol (e.g. LDAP). The analytics server 1110a may generate webpage content that is customized according to the user's role defined by the user record in the system database 1110b. For instance, the analytics server 1110 may customize the platform, such that a manager of the client 1140 views various data not accessible to other employees of the client 1140.

Client devices 1140a, 1150a may be any computing device comprising a processor and a non-transitory machine-readable storage medium capable of performing the various tasks and processes described herein. Non-limiting examples of these devices may include a workstation computer, laptop computer, tablet computer, and server computer. In operation, various users may use the client devices 1140a, 1150a to access the GUI operationally managed by the analytics server 1110a.

The administrator-computing device 1120 may represent a computing device operated by a system administrator. The administrator computing device 1120 may be configured to display data retrieved, results generated by the analytics server 1110a (e.g., various analytic metrics, AI training metrics (e.g., AUC, recall, precisions, or various thresholds associated with execution of the AI models described herein), and client proprietary data. The system administrator can monitor various models utilized by the analytics server 1110a, review feedback, and modify various thresholds, rules, and predetermined variables described herein.

Each client system may also include its own proprietary database (e.g., database 1140b and 1150b) where private, confidential, and/or proprietary client data may be stored (e.g., datasets 1140c and 1150c respectively). As discussed herein, each client may wish not to share this data publicly or with other clients. For instance, client system 1140 may requests that the analytics server 1110a trains and analyzes private/confidential data stored within the dataset 1140c and to display the results on the platform (only when accessed by the client device 1140c). The client system 1140 may not wish to share the dataset (or any data indicating the content of the dataset 1140c) with the client system 1150. In some configurations, the database 1140b and/or 1150b may be local databases that belong to and are hosted by the client system 1140 and/or 1150 respectively. For instance, the client system 1150 may provide to the analytic server 1110a access to the database 1140b, which is an internal database within the client system 1140.

The datasets 1140c, 1150c may include private operational data (e.g., loss events and other organizational data) associated with the client systems 1140, 1150. For instance, these datasets may include private trading data, loss data, corporate organization data, and the like. The database 1130 may include data used by the analytics server 1110a to train and/or execute the AI models described herein. For instance, the database 1130 may include market data, which is not proprietary data associated with either client system 1140, 1150. In some configurations, the data stored within the database 1130 may be proprietary to the analytics server 1110a but not client systems 1140, 1150. Therefore, the analytics server 1110a and/or the system administrator operating the administrator computing device 1120 may determine whether data stored within the database 1130 can be shared with any end-user/client.

In operation, the analytics server 1110a may employ the methods and systems described herein to generate/train AI model(s) and provide customized results for different clients. Specifically, the client systems 1140, 1150 may request the analytics server 1110a to analyze their confidential data (stored onto the datasets 1140c, 1150c respectively) and provide a risk of loss for each client individually.

The analytics server 1110a may then train the AI models described herein using the shared data (e.g., data stored onto the 1130) and each client's proprietary data. For instance, the analytics serve 1110a may train the AI models using dataset 1140c and data stored onto the database 1130. As a result, one or more weights and variables of the AI models may be customized and revised based on data that is specific to the client 1140. The customized/revised weights may correspond to specific attributes of the AI models that are specifically trained for the client 1140 because these variables/weights correspond to data stored within the dataset 1140c. Therefore, the analytics server stores the variables/weights onto the dataset 1140d. Data stored onto the database 1140b may not accessible to any other party other than the client 1140 or the analytics server 1110a. The analytics server 1110a may perform the same process to generate weights/variables specific to client 1150 (stored onto the dataset 1150c).

By training the AI models separately, the analytics server 1110a can provide services to different clients without co-mingling the data or using a model customized for one client with another client. For instance, when the analytics server 1110a receives a request to execute the AI models and generate results for the client 1140, the analytics server 1110a may use an application programming interface to retrieve data stored within the database 1130, dataset 1140c, and dataset 1140d. The analytics server 1110a may then execute the AI models and generate one or more risk scores indicating the likelihood of loss. The analytics server 1110a may then display the GUIs described in FIG. 7-10 on the computing device 1140a. Because data within the dataset 1140c is specific to the client 1140 and because the dataset 1140d corresponds to weights/variables of AI models trained using data that's specific to the client 1140, the results generated by the AI models are also customized and specific to the client 1140.

Similarly, the analytics server 1110a may execute the same AI model using data stored within the database 1130, dataset 1150c, and the dataset 1150d to generate results that are specific to the client system 1150. The analytics server 1110a may then display the results on the client device 1150a. The analytics server 1110a may not co-mingle proprietary data with other clients. For instance, data within the datasets 1140c-d may not be transmitted (e.g., displayed) on the platform displayed on the client device 1150a (and vice versa). Additionally, the AI model will not execute using data from both client system 1140 and client system 1150 at the same time. In this way, the analytics server 1110a may train the same model for two different clients without co-mingling each client's proprietary/confidential data. As a result, the analytics server 1110a may provide services to multiple clients without needing to reconfigure or retrain the AI models based on other client data and without co-mingling any client specific data.

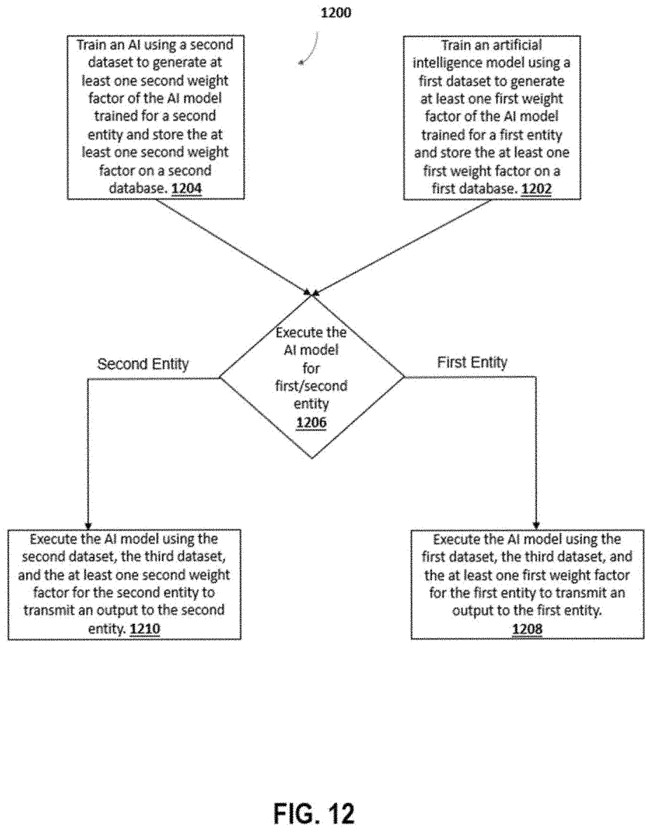

Referring now to FIG. 12, a flow diagram depicting a method for using artificial intelligence modeling to determine the probability for an operational loss event to occur is depicted, according to some embodiments. FIG. 12 illustrates a flowchart depicting operational steps performed by the analytics server in accordance with an embodiment. The method 1200 describes how a server, such as the analytics server described in FIG. 11, trains the AI models described herein and displays client-specific results without co-mingling each client's data. Even though the method 1200 is described as being executed by the analytics server, the method 1200 can be executed by any server(s) and/or performed locally using a computer/processor described herein (e.g., FIG. 1). Other configurations of the method 1200 may comprise additional or alternative steps, or may omit and/or mix one or more steps altogether.

The method 1200 describes how the analytics server can train an AI model for two different clients (sometimes referred to herein as the first entity in the second entity) without co-mingling each client's data. The method 1200 further describes how the analytics server may execute the same AI model for different clients to generate results that are customized for each client and to display the results without co-mingling each client's data.

At step 1202, the analytics server may train an AI model using a first dataset to generate at least one first weight factor of the machine learning model trained for a first entity and store the at least one first weight factor on a first database.

Upon receiving a request to generate results for a first entity, the analytics server may retrieve data specific to that entity. For instance, the analytics server may receive electronic authorization to access one or more databases that include operation data associated and specific to the first entity. In a non-limiting example, the analytics server may use an API to directly communicate with an internal database of the first entity. The analytics server may retrieve data that is specific and sometimes proprietary and confidential to the first entity, such as operation loss, trader data, employee data, and any data that could be used to train the AI models described herein to provide accurate operational loss data.

Using the retrieve data, the analytics server may use a variety of AI training techniques to train the AI models described herein. In some configurations, the analytics server may also use additional data (e.g., market data, indices, and the like) to train the AI models. The analytics server may use the additional data for all clients because the data may not be specific to each client. This dataset is referred to herein as the shared dataset. As a result of training the AI models, the analytics server may revise various variables, attributes, and weightings within the AI model. Because the newly revised variables and weightings are generated as a result of client-specific data, the new weightings and variables may be a part of client confidential material. As a result, the analytics server may not co-mingle variables, attributes, and weightings associated with different clients. In order to reduce the risk of co-mingling of data, the analytics server may generate a new dataset that corresponds to the newly revised variables, attributes, and weightings. The analytics server may then store that dataset within the client's database to avoid accidental co-mingling. In some embodiments, the analytics server may store the newly revised variables within an internal database. However, the analytics server may execute one or more tenant isolation protocols to avoid accidental co-mingling of the newly revised variables and weightings with other clients.

At step 1204, the analytics server may also train the AI model using a second dataset to generate at least one second weight factor of the machine learning model trained for a second entity and store the at least one second weight factor on a second database. The analytics server may use the same methods described in step 1202 to train the AI model for a second client/entity. As a result, the analytics server may generate a second dataset that includes weight factors generated as a result of training the AI model using data that is specific to the second entity. As described above, the analytics server may store the newly revised variables and weight factors for the second entity, such that the analytics server minimizes the chance of co-mingling data or other parameters.

The analytics server may perform the steps 1202 and 1204 in any particular order. For instance, the analytics server may simultaneously, synchronously, or asynchronously train the model for two different clients. For instance, the analytics server may train the AI model for the first client (1202) before, after, or during the same time the analytics server trains the model for the second client (1204).

At step 1206, the analytics server may execute the AI model. The execution of the AI model may be based on a predetermined frequency inputted by a system administrator and/or each entity. For instance, an entity may instruct the analytics server to execute the AI model every morning (or once a week). In another example, the analytics server may execute the AI model upon receiving a specific instruction from an entity. For instance, the second entity may access the platform described herein and may instruct the analytics server to generate operational loss likelihoods.

If the analytics server is executing the AI model for the first entity, the analytics server may move to the step 1208. At step 1208, the analytics server may execute the AI model using the first dataset, the shared dataset, and the at least one weight factor for the first entity to transmit an output to the first entity. The shared dataset may include data that is authorized to be accessed or otherwise used by either entity. For instance, the shared dataset may be data that does not include any confidential or proprietary information associated with either entity, such historical market data.

The analytics server may execute the AI model using the first entity's data (first dataset), the shared dataset, and weight factors generated in step 1202. For instance, the analytics server may execute an API call that automatically retrieves first entity specific data and the weight factors generated in step 1202, which may be stored onto a database associated with the first entity. As a result, the analytics server may no longer need to retrain or recalibrate the AI model because the customized weight factors and variables are retrieved from the dataset previously stored. Furthermore, the analytics server may generate results that are specific to the first entity because the AI model is customized to the first entity (by using weight factors specific to the first entity).

Upon execution of the AI model using first entity data, the analytics server may receive various risk scores/signals indicating a likelihood of operational loss. The analytics server may then populate an electronic platform accessed by a computing device associated with the first entity, as depicted in FIGS. 7-10.

If the analytics server is executing the AI model for the second entity, the analytics server may move to the step 1210. At step 1210, the analytics server may execute the machine learning model using the second dataset, the shared dataset, and the at least one weight factor for the second entity to transmit an output to the second entity. The analytics server may use methods similar as described in the step 1208 to generate and display customized results for the second entity.

Using the method 1200, the analytics server may train the same AI model for the first and the second entity where the analytics server does not co-mingle data from each entity during the training and/or execution of the AI models.

The embodiments described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

As used herein, the terms “server” and/or “processor” may include hardware structured to execute the functions described herein. In some arrangements, each respective “server” and/or “processor” may include machine-readable media for configuring the hardware to execute the functions described herein. The server may be embodied as one or more circuitry components including, but not limited to, processing circuitry, network interfaces, peripheral devices, input devices, output devices, sensors, etc. In this regard, the “server” or “processor” may include any type of component for accomplishing or facilitating achievement of the operations described herein.

The “server” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple servers (e.g., server A and server B may comprise or otherwise share the same processor, which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some arrangements, the one or more processors may be external to the apparatus, for example the one or more processors may be a remote processor (e.g., a cloud-based processor). Alternatively or additionally, the one or more processors may be internal and/or local to the apparatus. In this regard, a given server or components thereof may be disposed locally (e.g., as part of a local server, a local computing system) or remotely (e.g., as part of a remote server such as a cloud-based server). To that end, a “server” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data, which cause a general-purpose computer, special purpose computer, or special purpose processing machines to perform a certain function or group of functions. Each respective memory device may be operable to maintain or otherwise store information relating to the operations performed by one or more associated servers, including processor instructions and related data (e.g., database components, object code components, script components), in accordance with the example arrangements described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A method comprising:
detecting, by one or more processors, an occurrence of an event causing a change in accuracy of a risk predictive model of operational loss;
determining, by the one or more processors, the change in accuracy of the risk predictive model responsive to the occurrence of the event, the risk predictive model being trained with a training dataset causing the risk predictive model to generate a risk score indicative of a probability for an operational loss event to occur from a transaction having an incorrect transaction attribute, wherein the training dataset comprises operational loss data before the occurrence of the event; and
re-training, by the one or more processors responsive to determining the change in accuracy, the risk predictive model using a second training dataset comprising operational loss data after the occurrence of the event instead of the training dataset.

2. The method of claim 1, further comprising:
sending, by the one or more processors, a message that includes the one or more risk scores to a client device, the one or more risk scores being generated by the re-trained risk predictive model.

3. The method of claim 1, further comprising:
mapping, by the one or more processors, a first data record within the training dataset to a corresponding second data record within the second training dataset; and
replacing, by the one or more processors, the first data record with the second data record.

4. The method of claim 1, wherein the one or more processors receive an indication of an occurrence from a client device.

5. The method of claim 1, wherein the one or more processors receive the second training dataset from a client device.

6. The method of claim 1, wherein the second training dataset corresponds to operational loss data occurring after the occurrence of the event.

7. The method of claim 1, wherein the training dataset comprises at least one of historical market data, historical economic data, or historical security data and the second training dataset comprises market data, economic data, or security data occurring after the occurrence of the event.

8. A system comprising:
a server comprising a processor and a non-transitory computer-readable medium containing instructions that when executed by the processor causes the processor to perform operations comprising:
detecting an occurrence of an event causing a change in accuracy of a risk predictive model of operational loss;
determining the change in accuracy of the risk predictive model responsive to the occurrence of the event, the risk predictive model being trained with a training dataset causing the risk predictive model to generate a risk score indicative of a probability for an operational loss event to occur from a transaction having an incorrect transaction attribute, wherein the training dataset comprises operational loss data before the occurrence of the event; and
re-training, responsive to determining the change in accuracy, the risk predictive model using a second training dataset comprising operational loss data after the occurrence of the event instead of the training dataset.

9. The system of claim 8, wherein the instructions further cause the processor to:
send a message that includes the one or more risk scores to a client device, the one or more risk scores being generated by the re-trained risk predictive model.

10. The system of claim 8, wherein the instructions further cause the processor to:
map a first data record within the training dataset to a corresponding second data record within the second training dataset; and
replace the first data record with the second data record.

11. The system of claim 8, wherein the one or more processors receive an indication of an occurrence from a client device.

12. The system of claim 8, wherein the one or more processors receive the second training dataset from a client device.

13. The system of claim 8, wherein the second training dataset corresponds to operational loss data occurring after the occurrence of the event.

14. The system of claim 8, wherein the training dataset comprises at least one of historical market data, historical economic data, or historical security data and the second training dataset comprises market data, economic data, or security data occurring after the occurrence of the event.

15. A system comprising:
a client device; and
a server in communication with the client device, the server configured to:
detecting an occurrence of an event causing a change in accuracy of a risk predictive model of operational loss;
determining the change in accuracy of the risk predictive model responsive to the occurrence of the event, the risk predictive model being trained with a training dataset causing the risk predictive model to generate a risk score indicative of a probability for an operational loss event to occur from a transaction having an incorrect transaction attribute, wherein the training dataset comprises operational loss data before the occurrence of the event; and
re-training, responsive to determining the change in accuracy, the risk predictive model using a second training dataset comprising operational loss data after the occurrence of the event instead of the training dataset.

16. The system of claim 15, wherein the server is further configured to:
send a message that includes the one or more risk scores to a client device, the one or more risk scores being generated by the re-trained risk predictive model.

17. The system of claim 15, wherein the server is further configured to:
map a first data record within the training dataset to a corresponding second data record within the second training dataset; and
replace the first data record with the second data record.

18. The system of claim 15, wherein the one or more processors receive an indication of an occurrence from a client device.

19. The system of claim 15, wherein the one or more processors receive the second training dataset from a client device.

20. The system of claim 15, wherein the second training dataset corresponds to operational loss data occurring after the occurrence of the event.
